(19) United States
(12) Patent Application Publication
(10) Pub. No.: US 2012/0079281 A1
(43) Pub. Date: Mar. 29, 2012

(54) SYSTEMS AND METHODS FOR DIVERSIFICATION OF ENCRYPTION ALGORITHMS AND OBFUSCATION SYMBOLS, SYMBOL SPACES AND/OR SCHEMAS

(75) Inventors: David Lowenstein, Mississauga (CA); Risu Na, Mississauga (CA)

(73) Assignee: Lionstone Capital Corporation, Mississauga (CA)

(21) Appl. No.: 13/170,635

(22) Filed: Jun. 28, 2011

Related U.S. Application Data
(60) Provisional application No. 61/358,980, filed on Jun. 28, 2010.

(51) Int. Cl. G06F 21/00; H04L 9/28

(52) U.S. Cl. 713/189

(57) ABSTRACT

In some embodiments, a method includes generating a round key for each round from one or more rounds for encrypting input data and partitioning the input data into one or more data blocks for each round. A block key is generated for each data block and each data block is encrypted using the round key, the block key and the data block as inputs to a mathematic operation to produce a cipher text. A number of rounds is variable, at least one of a size of the round key or a number of data blocks are variable for each round, or at least one of a size of each data block, a size of the block key for each data block, the mathematic operation for each data block, or a size of the cipher text for each data block are variable for each data block within each round.

### CROSS-REFERENCE TO RELATED APPLICATION

This application claims priority to and the benefit of U.S. Provisional Patent Application No. 61/358,980, filed Jun. 28, 2010 and entitled “Systems and Methods for Diversification of Encryption Algorithms and Obfuscation Symbols and/or Schemas,” which is incorporated herein by reference in its entirety. This application is related to U.S. Patent Application bearing Attorney Docket No. FNTE-003/01US 313768-2006, filed on same date, and entitled “Seamless End-To-End Data Obfuscation and Encryption,” which claims the benefit of U.S. Provisional Patent Application No. 61/358,983, filed Jun. 28, 2010 and entitled “End-to-End Data Obfuscation and Encryption,” both of which are incorporated herein by reference in their entireties.

### BACKGROUND

One or more embodiments relate generally to diversification of algorithms, symbols and/or schemas used in encryption and/or obfuscation processes. More specifically, for example, one or more embodiments relates to diversification of encryption algorithms and obfuscation modules within a computing system.

Known systems and methods typically provide data security by encrypting and/or obfuscating information using known publicly-available or proprietary algorithms, confidential keys, symbols and/or schemas. In other words, known devices and software applications provide data security by relying on confidential keys and the strength of the publicly-available algorithms, in the case of encryption. When a weakness or flaw in an encryption algorithm or obfuscation schema used in multiple devices or software applications is discovered, each of the devices and software applications is susceptible to attacks based on the weakness or flaw in the algorithm or schema because each implements the same algorithm or schema.

### SUMMARY

In some embodiments, a method includes generating a round key for each round from one or more rounds for encrypting input data and partitioning the input data into one or more data blocks for each round. A block key is generated for each data block and each data block is encrypted using the round key, the block key and the data block as inputs to a mathematic operation to produce a cipher text. A number of rounds is variable, at least one of a size of the round key or a number of data blocks are variable for each round, or at least one of a size of each data block, a size of the block key for each data block, the mathematic operation for each data block, or a size of the cipher text for each data block are variable for each data block within each round.

### BRIEF DESCRIPTION OF THE FIGURES

FIG. 1 is a flow chart of a method for generating a diversified encryption algorithm, according to an embodiment.

FIG. 2 is a schematic block diagram of a device including a cryptographic engine, according to an embodiment.

FIG. 3 illustrates diversified obfuscation of data within a symbol space, according to an embodiment.

FIG. 4 is a block diagram of a system including diversified security modules, according to an embodiment.

FIG. 5 illustrates a sequence of diversified obfuscation and diversified encryption, according to an embodiment.

FIG. 6 illustrates another sequence of diversified obfuscation and diversified encryption, according to another embodiment.

FIG. 7 is a flow chart of a method for performing encryption, according to an embodiment.

FIG. 8 is a flow chart of a method for performing decryption, according to an embodiment.

FIG. 9 is a block diagram illustrating the cryptographic feature structure of an obfuscator and encryptor module, according to an embodiment.

### DETAILED DESCRIPTION

One or more embodiments described can provide improved resistance to security vulnerabilities within computing systems. Such described embodiments can, for example, strengthen potency of data at rest when used in a super encrypted and/or a super obfuscated manner, strengthen a system's ability to hide keys to improve resistance to reverse engineering, and strengthen software process, component or service data and code authentication. For example, a software module (e.g., an application or service) within a computing system can include a cryptographic engine that implements a diversified encryption and/or obfuscation algorithm, schema or process. A diversified encryption and/or obfuscation algorithm or schema can be an encryption algorithm or obfuscation schema that is unique or specific to a single or limited number of software modules (e.g., software processes, libraries, functions and/or classes) and/or devices. Software modules and/or devices that share a common diversified encryption algorithm and/or obfuscation schema can be referred to as complimentary. For example, a keyboard (e.g., a processor within a keyboard) and a complimentary software application can each include a cryptographic engine that implements a common diversified encryption algorithm and/or obfuscation schema. In other words, the diversified encryption algorithm and/or obfuscation schema is known or available only to the keyboard and the software application. Thus, data that is encrypted or obfuscated by the keyboard can be decrypted, deobfuscated, or otherwise properly interpreted, only (or exclusively) by the software application or that keyboard. Similarly, data that is encrypted or obfuscated by the software application can be decrypted, deobfuscated, or otherwise properly interpreted, only (or exclusively) by the keyboard or that software application. While described herein with respect to a keyboard, it should be understood that any other suitable input module, as described herein, can be used.

Additionally, devices and/or software applications can include or implement diversified data obfuscation modules (or diversified data obfuscation algorithms). Obfuscation modules transform data into an obfuscated state such that the data is not easily recognized in the obfuscated state. For example, the English alphabet can be obfuscated by transposing the letters such that, after transposition, an obfuscated letter represents a letter other than the obfuscated letter. More specifically, the letters in a sentence can be replace by their equivalents in an obfuscated or transposed alphabet such that the letter ‘a’ is represented by the letter ‘q’, the letter ‘b’ is represented by the letter ‘1’, and so forth. In some embodiments, numbers and/or other symbols can be obfuscated similarly to letters discussed above. Similar to diversified encryption algorithms, obfuscation modules can be diversified such that a diversified obfuscation module at a software module or device is unique or specific to that device or software module and complimentary devices and/or software applications. In other words, the algorithm used within a particular diversified obfuscation module can be implemented only in that obfuscation module and any complimentary obfuscation modules.

Diversified encryption algorithms and obfuscation modules are more resilient to security attacks because when one diversified encryption algorithm or obfuscation module is compromised (e.g., a weakness or flaw is discovered), other diversified encryption algorithms and obfuscation modules are not effected because these diversified encryption algorithms and obfuscation modules implement different encryption algorithms and obfuscation modules. Accordingly, an attacker compromises only a single diversified encryption algorithm and/or obfuscation module by discovering a flaw or weakness because that flaw or weakness does not typically exist in other diversified encryption algorithms and obfuscation modules.

In some embodiments, multiple diversified obfuscation modules and/or multiple diversified encryption algorithms can be used to obfuscate and/or encrypt data. In other words, multiple diversified obfuscation modules and/or multiple diversified encryption algorithms can be chained together to obfuscate and/or encrypt data. For example, a symbol representing a letter can be obfuscated using a first diversified obfuscation module to define a first obfuscated symbol. The first obfuscated symbol can then be obfuscated using a second diversified obfuscation module to define a second obfuscated symbol. The second obfuscated symbol can then be encrypted using a first diversified algorithm to define a first encrypted obfuscated symbol. The first encrypted obfuscated symbol can then be encrypted using a second diversified encryption algorithm to define a second encrypted obfuscated symbol.

Alternatively, a symbol can be obfuscated and encrypted by interleaving obfuscation and encryption. In other words, a symbol representing a letter can be obfuscated using a first diversified obfuscation module to define a first obfuscated symbol. The first obfuscated symbol can then be encrypted using a first diversified encryption algorithm to define a first encrypted obfuscated symbol. The first encrypted obfuscated symbol can then be obfuscated using a second obfuscation to define a second encrypted obfuscated symbol. The second encrypted obfuscated symbol can then be encrypted using a second diversified encryption algorithm to define a third encrypted obfuscated symbol. Such chaining of obfuscation modules and/or encryption algorithms can improve data security and resiliency against attacks.

In some embodiments, multiple chains of diversified obfuscation modules and/or diversified encryption algorithms and/or multiple interleaved diversified obfuscation modules and/or diversified encryption algorithms can be applied to data transferred between various software modules (e.g., software processes or applications, software libraries, software functions (i.e., C-language functions), and/or classes (i.e., C++ or Java™ classes)). In some embodiments, one chain of diversified obfuscation modules and/or diversified encryption algorithms can be applied to data transferred between two software modules and a set (or group) of interleaved diversified obfuscation modules and/or diversified encryption algorithms can be applied to data transferred between two different software modules. Furthermore, a chain of diversified obfuscation modules and/or diversified encryption algorithms and a set (or group) of interleaved diversified obfuscation modules and/or diversified encryption algorithms can be applied to data transferred between yet two additional software modules. Thus, various chains and/or sets of interleaved diversified obfuscation modules and/or diversified encryption algorithms can be applied to data transferred between different software modules.

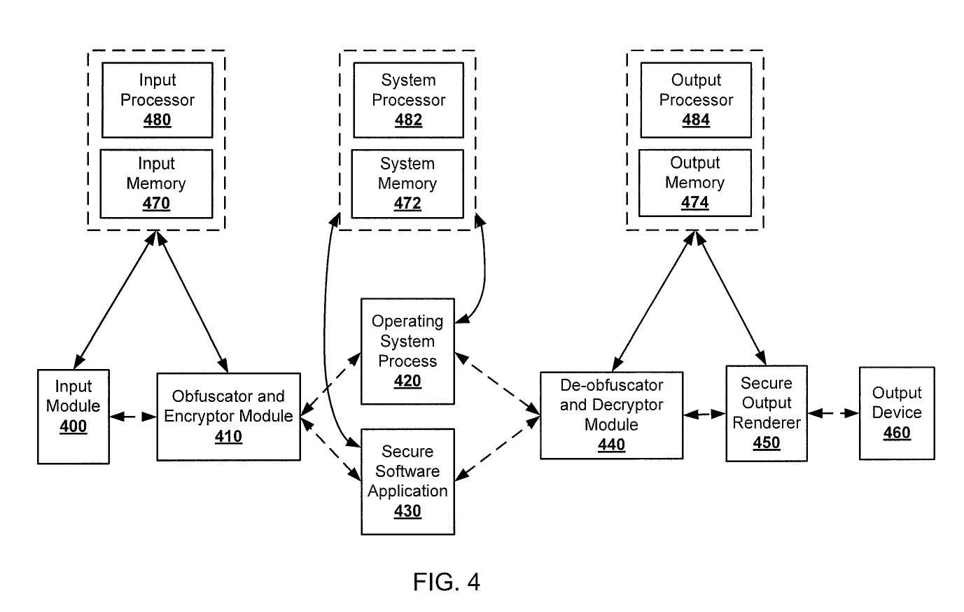

As used herein, the terms “secured channel” and “secure channel” mean a channel in which data is encrypted and/or obfuscated. In some embodiments, for example, a secured channel includes a cryptographic engine and/or an obfuscation module at a first end and a second end. Similarly stated, in some embodiments, for example, a secured channel includes an obfuscator module, an encyptor module or and obfuscator and encryptor module at a first end and a de-obfuscator module, a decryptor module or a de-obfuscator and decryptor module at a second end. The obfuscator module, the encryptor module or the obfuscator and encryptor module can obfuscate data, encrypt data or obfuscate and encrypt data before sending the data via the secured channel. Similarly, the de-obfuscator module, the decryptor module or the de-obfuscator and decryptor module can de-obfuscate data, decrypt data or de-obfuscate and decrypt data received from the obfuscator module, the encyptor module or the obfuscator and encryptor module via the secured channel. In some embodiments, the secure channel can be further protected using hardware isolated memory (as shown in FIG. 4), virtually isolated memory (i.e., memory curtaining) or obfuscated memory space (e.g., by shuffling or moving data in memory).

As used in this specification, the singular forms “a,” “an” and “the” include plural referents unless the context clearly dictates otherwise. Thus, for example, the term “a software module” is intended to mean a single software module or multiple software modules; and “memory” is intended to mean one or more memories, or a combination thereof.

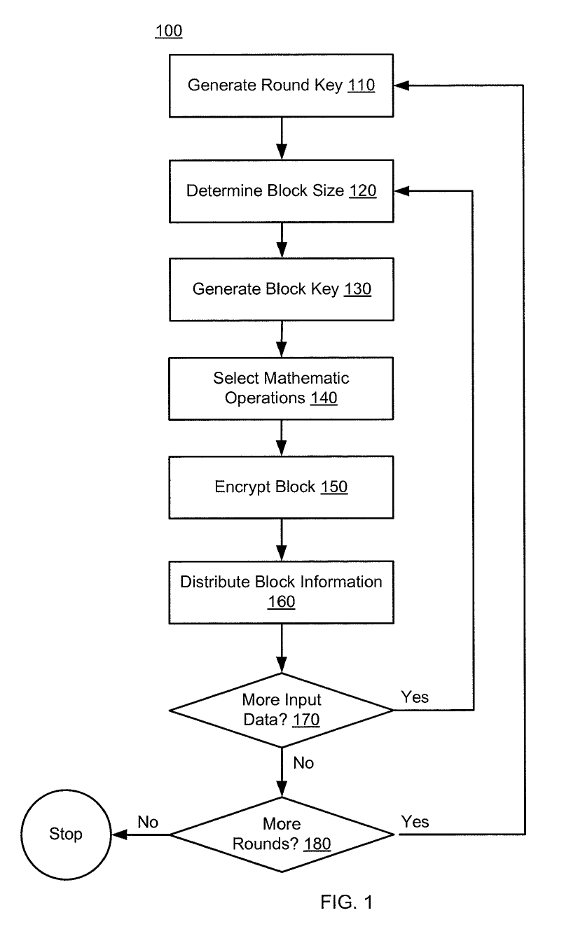

FIG. 1 is a flow chart of method 100 for generating a diversified encryption algorithm, according to an embodiment. A diversified encryption algorithm can be an encryption process that is specific or unique to a single or small number of encryption engines. For example, a diversified encryption algorithm can be specific to (1) an encryption engine within a particular input device such as a computer mouse or keyboard, (2) an encryption engine within a device driver or other software module (stored or executed in memory and/or executed at a processor) used to interface or communicate with that particular input device, (3) an encryption engine within a system process and/or (4) an encryption engine within an output device or driver. Thus, a one-to-one (or many-to-many) relationship can exist between encryption engines based on the diversified encryption algorithm.

A key for a round of encryption (a round key) is generated, at 110, from a portion of a key space. For example, the block key can be generated by selecting a portion of a key space or defining a value representing the block key based on some portion of the key space. The key space can be a data set such as a large collection of data or information from which a key can be selected or generated. For example, the key space can be a text document such as an encyclopedia, dictionary or other data set. In some embodiments, the key space can be obfuscated and/or encrypted. For example, the key space can be obfuscated by substituting values within the key space with other values. Additionally, a plaintext or obfuscated key space can be encrypted to generate a key space that is obfuscated as a cipher text key space.

110241 A portion of the key space can be selected based on selection criteria such as an output value from a random or pseudo-random number generator. For example, a set number of bits or some other quantum of data can be selected as a round key beginning at an offset within the key space specified by the output of a random number generator. In some embodiments, multiple portions of the key space can be selected and combined or concatenated to define the round key.

In some embodiments, the selected portion of the key space can be manipulated, operated on or further processed to generate the round key. For example, the selected portion of the key space can be input as a seed to a random number generator and the output of the random number generator can be used as a round key. Similarly, the bytes, bits, or some other quantum of data within the selected portion of the key space can be transposed or rearranged to define a round key.

After the round key is generated, a block size is determined, at 120. The block size can be different for each block of data to be encrypted. For example, a random or pseudo-random number generator can be used to determined a block size value that defines the size of a data set (i.e., a number of bytes that define an input block) used as the input to an encryption engine or process. A block key is then generated, at 130, for use during encryption of a block of data. Similar to the round key generated at 110, the block key is generated from a portion of a key space. For example, the block key can generated by selecting a portion of a key space or defining a value representing the block key based on some portion of the key space.

The block key can be selected based on selection criteria such as a random or pseudo-random seed from a random number generator. For example, a set number of bits or some other quantum of data can be selected as a block key beginning at an offset within the key space specified by the output of a random number generator. In some embodiments, multiple portions of the key space can be selected and combined or concatenated to define the block key. Furthermore, in some embodiments, the selected portion of the key space can be manipulated, operated on or further processed to generate the block key. For example, the selected portion of the key space can be input as a seed to a random number generator and the output of the random number generator can be used as a block key. Similarly, the bytes, bits, or some other quantum of data within the selected portion of the key space can be transposed or rearranged to define a block key.

Mathematic operations (or mathematic functions) are selected, at 140, to encrypt a block of data. That is, mathematic operations are selected from a library of mathematic operations, and these mathematic operations are then used, at 150, to encrypt a block of data. The library of mathematic operations can include logical operations such as XOR, OR, AND, NAND, or other logical operations. Additionally, the library of mathematic operations can include operations that move or otherwise manipulate bits, bytes, or other quantum of data in a block of data. For example, rotation, permutation and/or transposition operations can be included within the library of mathematic operations. Moreover, the library of mathematic operations can include expansion or compaction operations. The library of mathematic operations can also include substitution operations such as substitution boxes. Furthermore, the library of mathematic operations can include exponentiation operations such as exponentiation used in RSA cryptographic processes and/or geometric operations such as operations based on elliptic curves.

One or more mathematic operations are selected randomly or pseudo-randomly from the library of mathematic operations, at 140, and are then applied at 150 to the round key generated at 110, the block key generated at 130 and an input data block having a size determined at 120. In other words, the round key, the block key and the input data block are the operands to the mathematic operations selected at 140. The encrypting of the input data block at 150 produces (or defines) an output data block that is encrypted. Said differently, the encryption at 150 uses the round key and the block key as encryption keys, an input data block of the size determined at 120 as plaintext, and produces a cipher text output block.

After the cipher text output block is produced at 150, information about the input data block encrypted at 150 is added to the cipher text output block (or to a plain text output block). For example, parameters of the input data block such as the block size value can be represented by a number of bits (e.g., a binary string) and the bits can be randomly or pseudo-randomly distributed throughout the cipher text output block. Other information about or related to (or parameters of) the input data block such as, for example, a seed value for a pseudo-random number generator used to select mathematic operations at 140 or to determine the block size at 120 can also be added to the cipher text output block. Additionally, identifiers or values related to the mathematical operations selected at 140 can be added to or distributed within the cipher text output block, at 160. In some embodiments, the information about the input data block can be distributed within the cipher text output block based on a deterministic algorithm. In still other embodiments, any other information associated with the encryption algorithm can be distributed within the cipher text output block. For example, one or more parameters each associated with a number of rounds, a size of the round key for a round, a number of data blocks for a round, a size of a data block, a size of the block key for a data block, a mathematic operation for a data block, and/or a size of the cipher text for a data block can be distributed within the cipher text output block.

In some embodiments, the information associated with the input data and/or the encryption algorithm can be distributed within the cipher text output block (or within plain text) as encrypted or unencrypted data. In some embodiments, a location of the information within the cipher text output block can be random or pseudo-random. In such embodiments, for example, a location of the information within the cipher text can be different for a first agent or module (e.g., a first obfuscator and encryptor module) than for a second agent or module (e.g., a second obfuscator and encryptor module). In some embodiments, a location within the cipher text at which an agent or module distributes such information can be randomly selected and/or determined at a compile time of that agent, module or block, for at least one block of the cipher text. Thus, in some embodiments, after compilation, an instance of an agent or module is configured to distribute such information at a same location within cipher text each time method 100 is performed. In such embodiments, however, this location can be different for different agents, modules or blocks within an agent or module. Additionally, in some embodiments, the location within the remaining blocks of the cipher text (i.e., those not determined at compile time of the agent, module or block) can be selected and/or determined at either the compile time or the runtime. Similarly stated, at run-time, an agent or module can distribute such information to a specific location (randomly selected at compile-time of that agent or module) within the cipher text each time method 100 is performed. Thus, at run-time, a complementary agent or module (e.g., a complementary de-obfuscator and decryptor module) can retrieve the information from a same location within the cipher text each time that complementary agent or module receives data from its complementary agent or module.

In some embodiments, random symbols can be used within the cipher text to separate and/or delineate the information associated with the input data and the encrypted and/or obfuscated input data. In some embodiments, the random symbols for at least one block of the cipher text can be determined at a compile time. In such embodiments, the random symbols for the remaining blocks of the cipher text can be determined at runtime or the compile time.

In some embodiments, the block information about the input data block can be extracted (e.g., based on a seed to a pseudo-random process or number generator or a deterministic algorithm) from the cipher text output block and used during a related decryption process. For example, a complimentary agent implementing a decryption method based on method 100 (i.e., a complimentary decryption method) can extract the block information from the cipher text output. In other words, a complimentary agent such as a software module and/or device (stored or executed in memory and/or executed at a processor) implementing the decryption method (or process) is configured to extract the block information from the cipher text output block and use the block information during the decryption method (e.g., to determine a block size used during method 100).

In some embodiments, the block information is available at or communicated to a decryption process. That is, in some embodiments, the decryption process does not rely on the block information included within the cipher text output block to define parameters or values used within the decryption process. In some embodiments, the block information can be sent to a complimentary agent implementing the decryption process, for example, in a encrypted and/or obfuscated form (based on one or more diversified and/or conventional encryption algorithms and/or obfuscation modules) using out-of-band communication methods.

In some embodiments, the agent implementing and method 100 and a complimentary agent can include a common pseudo-random number generator that defines values from which block information is derived. For example, a block size value can be defined at the pseudo-random number generator. The complimentary agent can determine the block information by providing a particular seed to the pseudo-random number generator at the complimentary agent to cause that pseudo-random number generator to output the same sequence of pseudo-random values output by the agent implementing method 100. Thus, the complimentary agent can use the output values from the pseudo-random number generator at the complimentary agent to determine the block information.

In some embodiments, the block information can be included at each of the agent implementing method 100 and a complimentary agent. For example, block information such as a sequence of block sizes can be embedded or included within the agent and the complimentary agent.

If there are more input data to encrypt, at 170, method 100 returns to step 120 and steps 120 through 170 are repeated for each input data block in an input data set. Thus, a block size is determined, a block key is generated, and mathematic operations are selected for each input data block. Said differently, each input data block can have a size (e.g., a number of bytes) different than a size of other input data blocks and can be encrypted using a different block key and different mathematic operations from a block key and mathematic operations used to encrypt other input data blocks for a particular round of encryption. In other words, the encryption (e.g., block size and mathematic operations used to encrypt a block) can be different for each block of an input data set.

After the input data has been encrypted, at 170, additional rounds of encryption are processed, as illustrated at 180. The number of rounds of encryption can be determined by a predetermined value or by a pseudo-random number generator. If additional rounds of encryption should be performed, at 180, method 100 returns to 110 and a new round key is generated. Steps 120 through 170 are then repeated for the current round of encryption and any subsequent rounds of encryption.

In some embodiments, method 100 can include more or fewer steps than illustrated in FIG. 1. For example, step 160 can be excluded from method 100. Additionally, in some embodiments, steps of method 100 can be rearranged. For example, steps 120, 130 and 140 can be rearranged. In some embodiments, method 100 can include null or fake rounds in which no mathematic operations are applied to blocks during such rounds. For example, in some embodiments, any or all mathematic operations selected at 140 can be applied or performed, for example at 150, but no mathematic operations or encryption are performed on an input data set. Thus, method 100 can appear (e.g., to malicious software) to be performing operations, but such operations have no effect on the output encrypted data.

Furthermore, although method 100 illustrates diversified block encryption, diversified stream encryption can be implemented by processing a stream of data as each data symbol becomes available in the stream rather than processing input data one block at a time. Said differently, by fixing the block size at one symbol, diversified stream encryption algorithm can be implemented. Alternatively, diversified stream encryption algorithms can vary from the diversified encryption algorithm illustrates in FIG. 1.

Additionally, method 100 can be executed at one or more times. In some embodiments, method 100 can be executed when an agent is defined such that an instance of method 100 is included within the agent. In some embodiments, method 100 can be executed when an agent is instantiated at a host device such as a computing device. An agent can, therefore, include a particular instance of method 100 each time the agent is instantiated. In some embodiments, method 100 can be executed at runtime of an agent. In some embodiments, method 100 can be executed at multiple times.

Accordingly, in some embodiments, one or more portions of the method 100 can be varied. For example, a number of rounds from the one or more rounds can be varied. For another example, a size of the round key or a number of data blocks can be varied for each round. For yet another example, the size of each data block, a size of the block key for each data block, the mathematic operation for each data block, or a size of the cipher text for each data block can be varied for each data block within each round.

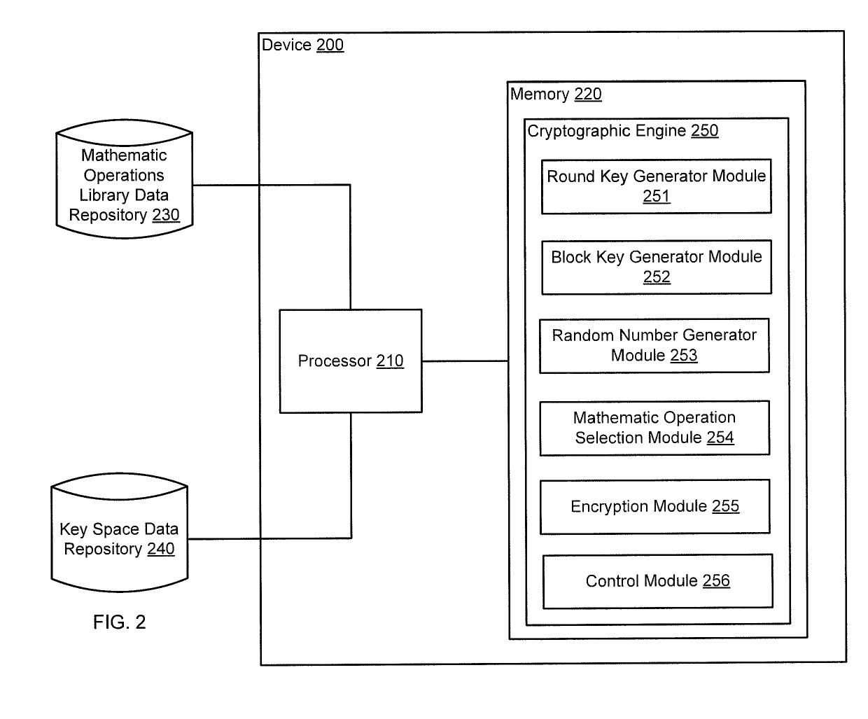

FIG. 2 is a schematic block diagram of device 200 including a cryptographic engine 250, according to an embodiment. Device 200 can be, for example, a computing device such as a computer server, a desktop computer, a laptop or notebook computer, a personal digital assistant (PDA), a smartphone, an embedded computing device, or some other computing device. As illustrated in FIG. 2, device 200 includes processor 210 and memory 220. Device 200 can also include one or more of the following (not shown): a network interface module; an input module such as a keyboard, computer mouse or touch-screen device; a video output module such as a graphics adapter module and/or a graphic display; a storage module such as a hard disk drive or solid-state drive; and/or other computing device peripherals.

Processor 210 is operatively coupled to memory 220 and is configured to execute instructions stored at memory 220. Said differently, processor 210 reads instructions from memory 220 and executes those instructions at processor 210 (e.g., within one or more processing cores or processing modules of processor 210). As illustrated in FIG. 2, processor 210 is operatively coupled to data repository 230 including a mathematic operation library. Additionally, processor 210 is operatively coupled to data repository 240 including a key space. Data repositories 230 and 240 can be local data repositories such as a random-access memory, FLASH memory or hard disk drive included within device 200, or remote data repositories such as a network attached or accessible storage device or service that is accessible to processor 210 via a network interface module and a network. In some embodiments, one of data repositories 230 and 240 is a local data repository and the other of data repositories 230 and 240 is a remote data repository. In some embodiments, one or both of data repositories 230 and 240 can be a portion of memory 220.

As discussed above, the key space at data repository 240 can be a data set such as a large collection of data or information from which a key can be selected or generated. For example, the key space can be a text document such as a digitized encyclopedia, dictionary or other data set. In some embodiments, the key space can be obfuscated and/or encrypted before it is accessed by modules of cryptographic engine 250. For example, the key space can be obfuscated by substituting values within the key space with other values. Additionally, a plain text or obfuscated key space can be encrypted to generate a key space that is obfuscated as a cipher text key space.

Similarly, as discussed above, the library of mathematic operations stored at data repository 230 can include logical operations such as XOR, OR, AND, NAND, or other logical operations. Additionally, the library of mathematic operations can include operations that move or otherwise manipulate bits, bytes, or other quantum of data in a block of data. For example, rotation, permutation and/or transposition operations can be included within the library of mathematic operations. Moreover, the library of mathematic operations can include expansion or compaction operations. The library of mathematic operations can also include substitution operations such as substitution boxes. Furthermore, the library of mathematic operations can include exponentiation operations such as exponentiation used in RSA cryptographic processes and/or geometric operations such as operations based on elliptic curves.

110471 Cryptographic engine 250 is stored at memory 220 and is hosted at processor 210. Said differently, instructions (e.g., processor code) that define cryptographic engine 250 can be stored at memory 220, and processor 210 executes the instructions that define cryptographic engine 250. In other words, cryptographic engine 250 runs or executes when the instructions defining cryptographic engine 250 are executed at processor 210. In some embodiments, cryptographic engine 250 can be included within an obfuscation and encryption module or a de-obfuscation and decryption module.

Cryptographic engine 250 can be a portion of a software module (e.g., object or executable code that defines instructions that are executable or interpretable at processor 210) that provides various services within device 200 and provides a diversified encryption algorithm to that software module. Such a software module can be referred to as an agent. In some embodiments, an agent can be a standalone or self-contained software module such as a software application (stored or executed in memory and/or executed at a processor). In some embodiments, an agent can be a software module that is attached to or injected into a software application at runtime. For example, the agent can be a dynamic link library that provides diversified encryption and/or obfuscation services and to which the software application dynamically binds. In some embodiments, an agent can be injected into a software application at runtime using code or software injection techniques. In some embodiments, an agent can be a virtual machine that hosts other software modules such as application programs and provides secure, diversified (or unique) encryption. In other words, the agent can host (i.e., run or execute) other software modules within a virtualized environment and can provide a secure layer of encryption to those software modules by encrypting data sent from the software modules using a diversified (or unique) encryption algorithm as discussed above in relation to FIG. 1.

Cryptographic engine 250 includes multiple software modules (stored or executed in memory and/or executed at a processor) including round key generator module 251, block key generator module 252, random number generator module 253, mathematic operation selection module 254, encryption module 255, and control module 256. Cryptographic engine 250 can implement a diversified encryption algorithm as discussed in relation to FIG. 1. Said differently, the multiple software modules of cryptographic engine 250 can be unique to cryptographic engine 250 within an agent and complimentary agents of that agent.

Random number generator module 253 can include instructions that are executable or interpretable at processor 210 to define random numbers or values used in a diversified encryption algorithm. For example, random number generator module 253 can be a pseudo-random number generator module such as a linear feedback shift register that is initialized with a seed value and includes a predetermined number of taps. The taps and seed can be unique to random number generator module 253 within cryptographic engine 250 of an agent and complimentary agents of that agent. Thus, random number generator module 253 can be configured to produce the same values at the agent and its complimentary agents for the diversified encryption algorithm of that agent. Alternatively, random number generator module 253 can be configured to produce non-repeatable sequences of random number values.

Round key generator module 251 can include instructions that are executable or interpretable at processor 210 to define a round key in a diversified encryption algorithm based on one or more portions of the key space stored at data repository 240. Block key generator module 252 can include instructions that are executable or interpretable at processor 210 to define a block key in a diversified encryption algorithm based on one or more portions of the key space stored at data repository 240. In some embodiments, round key generator module 251 and/or block key generator module 252 can access random number values defined at random number generator module 253 and define a round key or block key, respectively, based at least in part on one or more random number values.

Mathematic operation selection module 254 can include instructions that are executable or interpretable at processor 210 to select one or more mathematic operations from the mathematic operations library stored at data repository 230. In some embodiments, mathematic operation selection module 254 can access one or more random number values defined at random number generator module 253 and select one or more mathematic operations from the mathematic operations library stored at data repository 230.

Encryption module 255 can include instructions that are executable or interpretable at processor 210 to perform one or more encryption operations on an input (or plaintext) data block. For example, encryption module 255 can access a round key generated at round key generator module 251, a block key generated at block key generator module 252 and an input data block and perform one or more mathematic operations selected at mathematic operation selection module 254 on the round key, block key and input data block to generate and output (or encrypted) data block.

Control module 256 can include instructions that are executable or interpretable at processor 210 to control or coordinate an encryption process based on a diversified encryption algorithm. Said differently, control module 256 can implement a diversified encryption algorithm using the other software modules of cryptographic engine 250. For example, control module 256 can receive random number values from random number generator module 253 and provide these random number values to other software modules of cryptographic engine 250. Furthermore, control module 256 can receive a round key generated at round key generator module 251, a block key generated at block key generator module 252, and mathematic operations (or identifiers of mathematic operations) from mathematic operation selection module 254 and provide the round key, the block key, and the mathematic operations to encryption module 255 for use in the encryption of an input data block. In some embodiments, control module 256 can receive a random number value from random number generator module 253 and define an input data block based on that random number value. For example, control module 256 can select a block size (e.g., a number or bytes or bits) of input data to define an input data block based on a random number value from random number generator module 253.

In some embodiments, cryptographic engine 250 can be generated or defined by a centralized entity. That is, the centralized entity can define multiple agents, each of which includes a diversified encryption algorithm implemented within a cryptographic engine of that agent. Alternatively, in some embodiments, agents including cryptographic engines can be generated or defined at any of a number of distributed entities. In some embodiments, a computing device can receive (e.g., via a communications network) an agent from a remote entity. In some embodiments, a computing device can receive an agent from a local entity such as an entity hosted (e.g., executing or running at) that computing device or an entity operatively coupled to a common local communications network with that computing device. Furthermore, the cryptographic engine of each agent can implement a diversified (or unique) encryption algorithm. Said differently, the encryption algorithm implemented at each cryptographic engine can be unique from an encryption algorithms implemented at other cryptographic engines.

In some embodiments, agents and complimentary agents can be updated and/or replaced with a successor agent. A successor agent can be an updated agent (e.g., including new, additional and/or altered mathematic operations libraries, diversified encryption algorithms, diversified sets of obfuscated symbol spaces, and/or diversified obfuscation modules) that replaces or alters an existing agent or complimentary agent. In some embodiments, a successor agent can be encrypted and/or obfuscated using diversified encryption algorithms and/or diversified obfuscation modules that are unique to the agent and complimentary agents to which the successor agent is sent. Thus, only that agent and those complimentary agents can interpret the successor agent.

Successor agents can be distributed centrally or in a distributed matter. For example, a centralized entity can send a successor agent to an agent and complimentary agents to that agent. In some embodiments, the agent can receive the successor agent from, for example, a centralized entity, and the agent can distribute the successor agent to the complimentary agents. In some embodiments, complimentary agents can distribute or send a successor agent to other complimentary agents or the agent.

In some embodiments, one or more complimentary agents can be generated or defined for each agent such that the agent and any agent complimentary to that agent (a complimentary agent) can communicate one with another using the diversified encryption algorithm. In other words, because a cryptographic engine of an agent implements a diversified encryption algorithm, other agents that do not implement that diversified encryption algorithm cannot communicate with the agent using the diversified encryption algorithm. To enable the agent to communicate with other software modules (stored or executed in memory and/or executed at a processor), an entity can generate complimentary agents that implement a diversified encryption algorithm that is common with diversified encryption algorithm of the agent. The agent and the complimentary agents can then communicate using the diversified encryption algorithm.

For example, an agent can be or implement as a virtual machine that runs as an application within an operating system. The virtual machine can host application programs within the virtual machine such that the application programs are separated or insulated from the operating system. In some embodiments, the agent can provide encrypted and/or obfuscated input and output channels from input devices such as a keyboard, a computer mouse or a touch-screen display to the agent (or the application programs hosted at the agent), and from the agent (or the application programs hosted at the agent) to an output device such as a display adapter. Additional information related to encrypted and/or obfuscated input and output channels is discussed in U.S. Patent Application bearing Attorney Docket No. FNTE-003/01US 313768-2006, filed on same date, and entitled “Seamless End-To-End Data Obfuscation and Encryption.”

More specifically, for example, a keyboard (or other input module) can include a processor that hosts a complimentary agent and a graphics adapter can include a processor that hosts a complimentary agent. In some embodiments, such processors can be dedicated and/or custom processors configured to perform certain obfuscation and/or encryption functions and not other functions. Additionally, in some embodiments, the keyboard can include a memory configured to assist the processor in obfuscating and/or encrypting input data. Similarly, in some embodiments, the graphics adapter can include a memory configured to operate in conjunction with the processor in de-obfuscating and/or decrypting input data. In such embodiments, for example, the memories (e.g., at the keyboard and the graphics adaptor) can be dedicated memories such that other applications and/or processes are denied access to the memories.

When the keyboard receives an input signal from a user (e.g., a key of the keyboard is depressed), the processor hosting the complimentary agent at the keyboard can obfuscate and/or encrypt the signal (e.g., a scan code and/or ASCII value). The operating system receives the obfuscated and/or encrypted signal and sends the obfuscated and/or encrypted signal to the agent using, for example, standard message delivery mechanisms of the operating system. Because the signal is obfuscated and/or encrypted, malicious code or applications such as viruses, rootkits, or other malware or spyware cannot interpret the signal. The agent receives the obfuscated and/or encrypted signal and decrypts the signal using the diversified encryption algorithm and/or de-obfuscates the signal. The agent can then handle the signal. For example, the agent can provide the signal to a software application (stored or executed in memory and/or executed at a processor) hosted at the agent or the agent can perform processing or operations based on the signal either in the obfuscated or de-obfuscated form. In other words, the agent can use or interpret the obfuscated signal directly (i.e., in the obfuscated form) or indirectly (i.e., in the de-obfuscated form). After the agent has handled the signal, the signal or results of the signal can be displayed to the display device.

To further prevent malicious code or applications from accessing the signal and to provide a encrypted and/or obfuscated end-to-end channel for the signal, the agent can obfuscate and/or encrypt the signal before sending the signal to the display adapter. The obfuscated and/or encrypted signal is then sent to the display adapter using, for example, standard message delivery mechanisms of the operating system. The display adapter receives the obfuscated and/or encrypted signal and decrypts the signal using the diversified encryption algorithm and/or de-obfuscates the signal. The display adapter can then display the signal or results of the signal (e.g., movement of a cursor or display of a text character) either in the obfuscated or de-obfuscated form. Because the signal is obfuscated and/or encrypted when passing through the message delivery mechanisms of the operating system, the signal is secure against eavesdropping by malicious code or applications. Said differently, the signal passes through the message delivery mechanisms of the operating system within a secured channel defined by the obfuscation and/or encryption (e.g., data such as the signal is encrypted and/or obfuscated when passing through the channel).

In some embodiments, cryptographic engine 250 includes more or fewer software modules than those illustrated in FIG. 2. For example, in some embodiments, a cryptographic engine does not include a control module. Rather, the software modules of the cryptographic engine can communicate (e.g., provide signals related to values generated or determined at those software modules) one with another to realize (or implement) a diversified encryption algorithm. Thus, a random number generator module can provide random number values directly to other software modules within a cryptographic engine such as to a round key generator and/or to a block key generator. In some embodiments, a cryptographic engine can include an input data block selection module. The input data block selection module can receive one or more random number values from a random number generator module to determine a size (e.g., a number of bytes of bits) of an input data block. In some embodiments, a cryptographic engine can include a block information distribution module. The block information distribution module can receive information related to an input data block and add that information (e.g., binary values representing information related to the input data block) to an output data block of an encryption module.

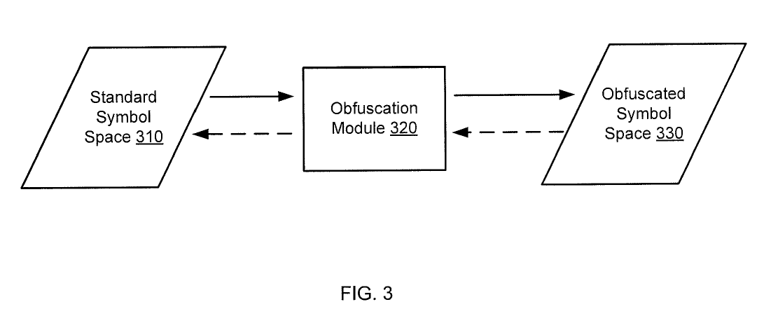

FIG. 3 illustrates an obfuscation module to obfuscate data within a symbol space, according to an embodiment. Data within standard symbol space 310 are provided to obfuscation module 320, and obfuscation module 320 translates or transforms the data from standard symbol space 310 to data within obfuscated symbol space 330, as illustrated by solid lines in FIG. 3. Obfuscation module 320 can perform the translation or transformation using any of a variety of translation or transformation operations. For example, standard symbol space 310 can be an 8-bit symbol space including standard ASCII values. Obfuscation module 320 can perform a substitution of the ASCII values such that obfuscated symbol space 330 is an 8-bit symbol space in which the ASCII values have been shuffled or transposed. In some embodiments, obfuscated symbol space 330 can be larger than standard symbol space 320. For example, obfuscation module 320 can map an 8-bit standard symbol space 310 to a 16- or 32-bit obfuscated symbol space 330.

The mapping between standard symbol space 310 and obfuscated symbol space 330 can be a one-to-one mapping in which only a subset of the symbols in obfuscated symbol space 330 represent symbols from standard symbol space 310 and the remaining symbols in obfuscated symbol space 330 do not represent symbols from standard symbol space 310. In some embodiments, multiple symbols in obfuscated symbol space 330 can represent a single symbol in standard symbol space 310. This can be useful to distribute symbols in standard symbol space 310 within obfuscated symbol space 330 with a statistical frequency that differs from the statistical frequency of occurrence of those symbols in standard symbol space 310. In other words, a symbol in standard symbol space 310 that represents the letter ‘e’ has a relatively high statistical frequency of occurrence in English language data sets in standard symbol space 310 because the letter ‘e’ is the most frequently used letter in the English language. To prevent statistical frequency analyses on the data set in obfuscated symbol space 330, the letter ‘e’, for example, can be translated or mapped to two or more symbols within obfuscated symbol space 330. Thus, an attacker cannot merely compare the frequencies of symbols in obfuscated symbol space 330 to the frequencies of the original symbols in standard symbol space 310 to determine the mappings of symbols between obfuscated symbol space 330 and standard symbol space 310. Furthermore, obfuscation module 320 can map each of numerous symbols from standard symbol space 310 to multiple symbols in obfuscated symbol space 330 to provide a substantially uniform distribution of symbols in obfuscated symbol space 330. In some embodiments, multiple diversified obfuscation modules can be chained together (i.e., the output of one obfuscation module becomes the input (or is input) to a subsequent diversified obfuscation module), interleaved with an encryption algorithm (as described above), and/or alternated between software modules.

In addition to translation or mapping, obfuscation module 320 can perform logical operations such as XOR, AND, OR, NAND, bit-shifts, bit-rotations, and/or other logical operations on symbols in standard symbol space 310 to transform those symbols into symbols in obfuscated symbol space 330. In some embodiments, obfuscation module 320 can perform various mathematic operations to transform symbols in standard symbol space 310 into symbols in obfuscated symbol space 330. In some embodiments, obfuscation module 320 can perform cryptographic operations on symbols in standard symbol space 310 based on one or more cryptographic keys to transform symbols in standard symbol space 310 into symbols in obfuscated symbol space 330.

In addition to translating or transforming the data (e.g., symbols representing data) from standard symbol space 310 to data within obfuscated symbol space 330, obfuscation module 320 can perform the complimentary operation (illustrated by broken lines in FIG. 3) of translating or transforming data from obfuscated symbol space 330 to data within standard symbol space 310. In other words, obfuscation module 320 can de-obfuscate data sets from obfuscated symbol space 330 to standard symbol space 310. In other embodiments, an agent can perform one or more operations on a data set (e.g., symbols) in obfuscated symbol space. Said differently, in some embodiments, an agent can use obfuscated symbols directly.

As discussed above in relation to diversified encryption algorithms, a cryptographic engine can be generated or defined by a centralized entity and can include a diversified or unique set of obfuscated symbol spaces or obfuscation module. In other words, an entity can define multiple agents, each of which includes a diversified set of obfuscated symbol spaces or obfuscation module implemented within a cryptographic engine of that agent (e.g., a software application or a computing hardware device). In some embodiments, agents including set of obfuscated symbol spaces or cryptographic engines can be generated or defined at any of a number of distributed entities. Furthermore, the set of obfuscated symbol spaces or cryptographic engine of each agent can implement a diversified (or unique) obfuscation module. Said differently, the set of obfuscated symbol spaces or obfuscation module implemented at each cryptographic engine can be unique from an obfuscation module implemented at other cryptographic engines.

Each diversified obfuscation module can be based on a set of obfuscated symbol spaces or an algorithm that is different from an algorithm of other obfuscation modules implemented at other cryptographic engines. For example, one obfuscation module can map at standard symbol space with a given symbol size to an obfuscated symbol space with a different symbol size, without limitation as to the size of the symbol space. As an illustrative example, one obfuscation module can map at 16-bit standard symbol space to a 32-bit, 64-bit, 128-bit or larger obfuscated symbol space, and another obfuscation module can shuffle or transpose symbols within a 16-bit standard symbol space to produce symbols in a 16-bit obfuscated symbol space.

Additionally, as discussed above, one or more complimentary agents can be generated or defined for each agent such that the agent and any agent complimentary to that agent (a complimentary agent) can communicate one with another using the diversified set of obfuscated symbol spaces or obfuscation module. In other words, because a cryptographic engine of an agent implements a diversified set of obfuscated symbol spaces or obfuscation module, other agents that do not implement that diversified set of obfuscated symbol spaces or obfuscation module cannot communicate with the agent using the set of obfuscated symbol spaces or diversified obfuscation module. To enable the agent to communicate with other software modules (stored or executed in memory and/or executed at a processor), complimentary agents that implement a diversified set of obfuscated symbol spaces or obfuscation module that is common with (i.e., the same as) the diversified set of obfuscated symbol spaces or obfuscation module of the agent can be generated. The agent and the complimentary agents can then communicate using the diversified set of obfuscated symbol spaces or obfuscation module. In other words, because each of the agent and the complimentary agents implement the diversified set of obfuscated symbol spaces or obfuscation module, the agent and the complimentary agents can interpret signals that have been obfuscated by the agent and the complimentary agents.

Diversified encryption algorithms and diversified obfuscation modules can be used in various combinations with one another and with other encryption algorithms to enhance data security and/or to improve resistance to reverse engineering. For example, a diversified encryption algorithm can be used to encrypt data sets that have previously been encrypted using other encryption algorithms. For example, a data set encrypted using one or more of the following algorithms can be encrypted using a diversified encryption algorithm: AES, DES, Blowfish, RSA, RC4, RSA, or ElGamal. A result of encrypting such encrypted data sets using diversified encryption algorithms is that the resulting cipher text (or encrypted data set) is less susceptible to flaw or weaknesses discovered in other computing systems because the diversified encryption algorithm is unique to the computing system implementing the diversified encryption algorithm (and any complimentary computing systems). Additionally, such encryption takes advantage of the robustness, research and security of publicly-available and proven encryption algorithms without being subject to a weakness found in any one of such algorithms.

110721 In some embodiments, an agent or other software module or device (stored or executed in memory and/or executed at a processor) can implement multiple diversified encryption algorithms such as one or more symmetric key block encryption algorithms and one or more stream encryption algorithms. The output of one diversified encryption algorithm can be used as the input to another diversified encryption algorithm. For example, an input (plaintext) data set can be encrypted using a diversified symmetric key block encryption algorithm and the resulting (cipher text) data set can be encrypted using a diversified stream encryption algorithm or a different diversified symmetric key block encryption algorithm to produce an output (cipher text) data set.

Moreover, in some embodiments, multiple diversified encryption algorithms can be used to encrypt data sets encrypted by standard or publicly-available encryption algorithms. In other words, an input data set can be encrypted using a standard or publicly-available encryption algorithm and the output can be encrypted using a diversified encryption algorithm. That output can then be encrypted using a different standard or publicly-available encryption algorithm and the output can be encrypted using another diversified encryption algorithm. Alternatively, other combinations of standard or publicly-available encryption algorithms and diversified encryption algorithms can be used to encrypt an input data set.

In some embodiments, one or more diversified obfuscation modules can be used with one or more diversified encryption algorithms and/or one or more standard or publicly-available encryption algorithms. The one or more diversified obfuscation modules and/or the one or more diversified encryption algorithms and/or one or more publicly-available encryption algorithms can be selected from one or more libraries of obfuscation modules and/or encryption algorithms. For example, the output of a diversified obfuscation module can be provided to a standard or publicly-available encryption algorithm, and the output of the standard or publicly-available encryption algorithm can be provided to a diversified encryption algorithm. Thus, an obfuscated representation of a signal (e.g., an input to an obfuscation module) can be encrypted using both a standard or publicly-available encryption algorithm and a diversified encryption algorithm. Additionally, as discussed above, multiple diversified encryption algorithms and/or multiple standard or publicly-available encryption algorithms can be used to encrypt an obfuscated data set or signal. Furthermore, a signal or data set can be obfuscated at multiple obfuscation modules each implementing a different diversified obfuscation algorithm.

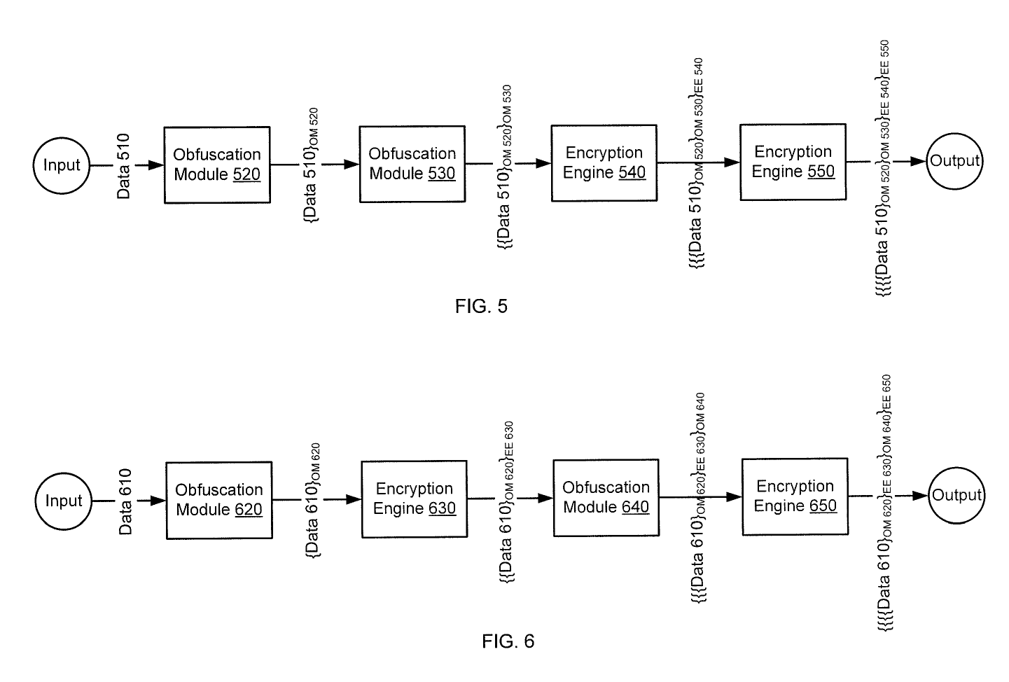

For example, FIG. 5 illustrates a sequence of diversified obfuscation and diversified encryption, according to an embodiment, and FIG. 6 illustrates another sequence of diversified obfuscation and diversified encryption, according to another embodiment. The sequences illustrated in FIGS. 5 and 6 can be referred to as secured chains. Obfuscation modules 520, 530, 620 and 640 and encryption engines 540, 550, 630 and 650 can be selected from one or more libraries of obfuscation modules and/or encryption engines. Furthermore, obfuscation modules 520, 530, 620 and 640 and encryption engines 540, 550, 630 and 650 can be diversified. Additionally, the sequences of obfuscation modules 520, 530, 620 and 640 and encryption engines 540, 550, 630 and 650 in FIGS. 5 and 6 can be determined randomly, pseudo-randomly, and/or by predetermined selection criteria.

110761 Obfuscation modules 520, 530, 620 and 640 and encryption engines 540, 550, 630 and 650 can be implemented at one or more software modules (stored or executed in memory and/or executed at a processor), agents and/or as components of agents (or complimentary agents or supplemental agents). For example, obfuscation modules 520, 530, 620 and 640 and encryption engines 540, 550, 630 and 650 can be software modules (stored or executed in memory and/or executed at a processor) such as functions, classes, libraries, frameworks, and/or other software modules. Additionally, obfuscation modules 520, 530, 620 and 640 and encryption engines 540, 550, 630 and 650 can be implemented as hardware devices. Moreover, obfuscation modules 520, 530, 620 and 640 and encryption engines 540, 550, 630 and 650 can be implemented at different agents. For example, FIG. 5 can be an illustration of data 510 as it passed through four agents: the first agent implementing obfuscation module 520, the second agent implementing obfuscation module 530, the third agent implementing encryption engine 540, and the fourth agent implementing encryption engine 550. In some embodiments, obfuscation modules 520, 530, 620 and 640 and encryption engines 540, 550, 630 and 650 can be implemented as hardware devices can be implemented at a single agent.

As illustrated in FIG. 5, data 510 are input to obfuscation module 520 to define {data 510}_{OM 520}, which represents data 510 obfuscated at obfuscation module 520. {Data 510}_{OM 520} are input to obfuscation module 530, and obfuscation module 530 defines {{Data 510}_{OM 520}}_{OM 530} based on {Data 510}_{OM 520}. {{{Data 510}_{OM 520}}_{OM 530}} are input to encryption engine 540, and encryption engine 540 defines {{{Data 510}_{OM 520}}_{OM 530}}_{EE 540} based on {{Data 510}_{OM 520}}_{OM 530}. {{{Data 510}_{OM 520}}_{OM 530}}_{EE 540} are input to encryption engine 550, and encryption engine 550 defines {{{{Data 510}_{OM 520}}_{OM 530}}₅₅₀ based on {{{Data 510}_{OM 520}}_{OM 530}}_{EE 540}. Thus, multiple obfuscation modules and/or encryption engines can be chained together to define encrypted and obfuscated data.

As illustrated in FIG. 6, data 610 are input to obfuscation module 620 to define {Data 610}_{OM 620}, which represents data 610 obfuscated at obfuscation module 620. {Data 610}_{OM 620} are input to encryption engine 630, and encryption engine 630 defines {{Data 610}_{OM 620}}_{EE 630} based on {Data 610}_{OM 620}. {{{Data 610}_{OM 620}}_{EE 630}} are input to obfuscation module 640, and obfuscation module 640 defines {{{Data 610}_{OM 620}}_{EE 630}}_{OM 640} based on {{Data 610}_{OM 620}}_{EE 630}. {{{Data 610}_{OM 620}}_{EE 630}}_{OM 640} are input to encryption engine 650, and encryption engine 650 defines {{{{Data 610}_{OM 620}}_{EE 630}}_{OM 640}}_{EE 650} based on {{{Data 610}_{OM 620}}_{EE 630}}_{OM 640}. In some embodiments, other configurations of chains of obfuscation modules and/or encryption engines are possible to define encrypted and obfuscated data.

FIG. 4 is a schematic illustration of a system including diversified security modules, according to an embodiment. More specifically, FIG. 4 illustrates an input module 400 operatively and/or physically coupled to an obfuscator and encryptor (hereinafter “O & E”) module 410 (also referred to as an obfuscator and encryptor agent). O & E module 410 and/or input module 400 is operatively coupled to an operating system process 420 and a secure software application 430 (also referred to as a secure software agent) stored in a memory (not shown in FIG. 4). Operating system process 420 and secure software application 430 are operatively coupled to a data decryptor and/or de-obfuscator (hereinafter “D & D”) module 440 (also referred to as a decryptor and de-obfuscator agent), which is operatively coupled to a secure output renderer 450 (also referred to as a secure renderer agent). Secure output renderer 450 is operatively coupled to an output device 460.

O & E module 410 and D & D module 440 are complementary to an obfuscator and/or encryptor module of secure software application 430. Said differently, O & E module 410 and D & D module 440 can be (or can implement) agents that are complimentary to secure software application 430. Thus, secure software application 430, O & E module 410 and D & D module 440 implement a common diversified encryption algorithm and/or a common diversified obfuscation module. Such a system can be similar to the systems shown and described in U.S. Patent Application bearing Attorney Docket No. FNTE-003/01US 313768-2006, filed on same date, and entitled “Seamless End-To-End Data Obfuscation and Encryption,” which is incorporated herein by reference in its entirety.

In some embodiments, O & E module 410 can be said to be a security module and/or an obfuscator-encryptor module. Similarly, in some embodiments, O & E module 410 can be said to include an obfuscator module (also referred to as an obfuscation module), an encryptor module (also referred to as an encryption engine or a cryptographic engine), or both an obfuscator module and an encryption engine. In some embodiments, D & D module 440 can be said to be a security module and/or a de-obfuscator-decryptor module. Similarly, in some embodiments, D & D module 440 can be said to include a de-obfuscator module (also referred to as a de-obfuscation module), an decryptor module (also referred to as a decryption module or a cryptographic engine), or both a de-obfuscator module and a decryption module.

Input module 400 can be any suitable hardware-based device and/or software-based interface configured to receive user input data. For example, input module 400 can be a physical keyboard, a virtual (on-screen) keyboard, a computer mouse, trackpad, trackpoint, joystick, controller, microphone (e.g., for capturing voice or other commands), optical camera, a touch-screen display configured to receive input gestures (e.g., a tap, swipe, or other input gesture), a biometric scanner (e.g., fingerprint scanner, retina scanner, etc.), a biometric sensor, a proximity card scanner, a barcode scanner and/or any other suitable input module. While described herein with respect to a keyboard, it should be understood that any suitable input module, as described above, can be used.

In some embodiments, input module 400 can be coupled to O & E module 410 by a physical cable (not shown in FIG. 4). In some embodiments, O & E module 410 can be physically disposed within input module 400. In some embodiments, input module 400 can be operatively coupled to O & E module 410 by a wireless protocol, such as Bluetooth, Wireless Universal Serial Bus (Wireless USB), Radio Frequency Identification (RFID), etc. In some embodiments, O & E module 410 can be a hardware-isolated software component. In some embodiments, the secure, seamless input/output system illustrated in FIG. 4 can include multiple input modules configured to receive input data in text, audio, graphic, or video form, used singularly, or in aggregate.

O & E module 410 can be a hardware-based module and/or software-based interface (stored or executed in memory and/or executed at a processor) configured to receive input data from input module 400 and obfuscate and/or encrypt the input data using a diversified security algorithm such that the input data's content or meaning is not discernible to outside sources, processes, or individuals. In some embodiments, O & E module 410 can obfuscate and/or encrypt the input data in a diversified manner, according to, for example, a diversified obfuscation and/or encryption algorithm diversified to an individual user and/or individual input module, as described herein. In some embodiments, O & E module 410 can be a hardware-based module physically disposed within input module 400. In some embodiments, O & E module 410 can be a hardware-isolated software component. In such embodiments, the combination of input module 400 and O & E module 410 can be referred to as a “black box input obfuscator”, inasmuch as the two modules together receive input data and transform it into an uninterpretable form before transmitting the input data further—thereby allowing for no unauthorized detection of the plain-text input by another process, device or individual. In some embodiments, O & E module 410 can be, for example, a processor, an application-specific integrated circuit (ASIC), hardware-isolated software (stored or executed in memory and/or executed at a processor), or a field programmable gate array (FPGA) disposed within, for example, a physical keyboard or computer mouse. In some embodiments, O & E module 410 can be a custom hardware-based module configured to obfuscate and/or encrypt input data according to a custom and/or diversified algorithm. In such embodiments, for example, O & E module 410 can be a dedicated and/or custom processor configured to perform certain obfuscation and/or encryption functions without being capable of performing other functions.

In some embodiments, the O & E module 410 and/or the input module 400 can operate on, use and/or include input memory 470 configured to operate in conjunction with input processor 480 in obfuscating and/or encrypting input data. In such embodiments, for example, the input memory 470 can be a dedicated memory such that other applications and/or processes are denied access to the input memory 470. The input memory 470 can store the O & E module 410 itself as well as the data being manipulated by the O & E module 410. Similarly, in such embodiments, the input processor 480 can be a dedicated and/or custom processor configured to be used by the input module 400 and/or the O & E module 410 without being used by other modules, applications and/or processes. Such other modules, applications and/or processes can use another memory and/or processor (e.g., system memory 472 and/or system processor 482). As shown in FIG. 4, the input memory 470 can be protected using hardware-isolated memory. In such embodiments, the input memory 470 is physically isolated from the system memory 472 and the output memory 474. Thus, both the O & E module 410 itself as well as the data being manipulated by the O & E module 410 can be isolated from the system memory 472 and the output memory 474. In other embodiments, the input memory 470 can be protected using virtually isolated memory (i.e., memory curtaining) or obfuscated memory space (e.g., by shuffling or moving data in memory). In other embodiments, the O & E module 410 and/or the input module 400 can share input memory 470 and/or input processor 480 with secure software application 430, operating system process 420, D & D module 440, secure output renderer 450, output device 460 and/or other modules, applications and/or processes.

In some embodiments, O & E module 410 can be a hardware dongle device physically coupled to input module 400. In such embodiments, the hardware dongle device can transmit obfuscated and/or encrypted input data to operating system process 420 and/or software application 430 via a serial, USB, wireless or other known hardware device connection methods or protocols.

Operating system process 420 can be any standard operating system process, such as a process defined to execute on a Microsoft Windows, Linux, OS X, OS/2, Solaris, Apple iPhone OS, Google Android, Palm OS, or other operating system. Although only one operating process is shown in FIG. 4, it should be understood that in some embodiments, multiple operating system processes are possible. Secure software application 430 can be any valid software application designed to receive and decrypt encrypted and obfuscated data, process the obfuscated data to perform or provide the application's intended function, and re-encrypt and send the data to another module or device. In some embodiments, secure software application 430 can also de-obfuscate the data prior to processing the data and re-obfuscate the data prior to sending the data to another module or device. Accordingly, in some embodiments, the secure software application 430 can be said to be an agent including a cryptographic engine and/or an obfuscation module. In some embodiments, secure software application 430 can perform or provide the application's intended function without decrypting and/or de-obfuscating the data. In some embodiments, secure software application 430 can be a secure word processing, secure web browsing, or other secure software application. In some embodiments, secure software application 430 can be a secure version of a known software application generated by an automated application-securing process. In some embodiments, secure software application 430 can be a typical, unsecure version of a known software application that includes or executes a secure application agent (not shown in FIG. 4) capable of performing the receiving, de-obfuscation, decryption, processing, re-obfuscation, re-encryption, and sending described above. In other words, the secure application agent (such as secure software application 430) can be hosted or executed within other software modules (stored or executed in memory and/or executed at a processor), thereby providing a secure layer of encryption and/or obfuscation to those software modules by encrypting and/or obfuscating data sent from the software modules using a diversified (or unique) encryption or obfuscation algorithm.

As described above, the operating system process 420 and/or the secure software application 430 can operate on, use and/or include system memory 472 configured to operate in conjunction with system processor 482. In such embodiments, for example, the system memory 472 can be a dedicated memory such that other applications and/or processes are denied access to the memory. The system memory 472 can store the operating system process 420 and/or the secure software application 430 itself as well as the data being manipulated by the operating system process 420 and/or the secure software application 430. Similarly, in such embodiments, the system processor 482 can be a dedicated and/or custom processor configured to be used by the operating system process 420 and/or the secure software application 430 without being used by other modules, applications and/or processes. Such other modules, applications and/or processes can use another memory and/or processor (not shown in FIG. 4). As shown in FIG. 4, the system memory 472 can be protected using hardware-isolated memory. In such embodiments, the system memory 472 is physically isolated from the input memory 470 and the output memory 474. Thus, the operating system process 420 and/or the secure software application 430 itself as well as the data being manipulated by the operating system process 420 and/or the secure software application 430 can be isolated from the input memory 470 and the output memory 474. In other embodiments, the system memory 472 can be protected using virtually-isolated memory (i.e., memory curtaining) or obfuscated memory space (e.g., by shuffling or moving data in memory). In other embodiments, the operating system process 420 and/or the secure software application 430 can share system memory 472 and/or system processor 482 with O & E module 410, input module 400, D & D module 440, secure output renderer 450, output device 460 and/or other modules, applications and/or processes.

D & D module 440 can be a hardware-based module and/or software-based interface (stored or executed in memory and/or executed at a processor) configured to receive encrypted and/or obfuscated input data (i.e., “secured input data”) from operating system process 420 and/or software application 430. D & D module 440 can then de-obfuscate and/or decrypt the secured input data such that the now-unsecured input data can be rendered by secure output renderer 450 to an output device 460. In some embodiments, D & D module 440 can be a hardware-based module physically disposed within secure output renderer 450. For example, D & D module 440 can be a processor, an application-specific integrated circuit (ASIC), hardware-isolated software, or a field programmable gate array (FPGA) disposed within, for example, secure output renderer 450, where secure output renderer 450 is a hardware video card or other subcomponent of the computing device. In such embodiments, D & D module 440 can be configured to both decrypt and de-obfuscate secured input data and send the resulting unsecured data directly to secure output renderer 450 for subsequent output to output device 460. In some embodiments, D & D module 440 can be a dedicated and/or custom processor configured to perform certain de-obfuscation and/or decryption functions without being capable of performing other functions.

In some embodiments, the D & D module 440 and/or the secure output renderer 450 can operate on, use and/or include output memory 474 configured to operate in conjunction with output processor 484 in de-obfuscating and/or decrypting data. In such embodiments, for example, the output memory 474 can be a dedicated memory such that other applications and/or processes are denied access to the output memory 474. The output memory 474 can store the D & D module 440 itself as well as the data being manipulated by the D & D module 440. Similarly, in such embodiments, the output processor 484 can be a dedicated and/or custom processor configured to be used by the D & D module 440 and/or the secure output renderer 450 without being used by other modules, applications and/or processes. Such other modules, applications and/or processes can use another memory and/or processor (e.g., system memory 472 and/or system processor 482). As shown in FIG. 4, the output memory 474 can be protected using hardware isolated memory. In such embodiments, the output memory 474 is physically isolated from the system memory 472 and the input memory 470. Thus, both the D & D module 440 itself as well as the data being manipulated by the D & D module 440 can be isolated from the system memory 472 and the input memory 470. In other embodiments, the output memory 474 can be protected using virtually isolated memory (i.e., memory curtaining) or obfuscated memory space (e.g., by shuffling or moving data in memory). In other embodiments, the D & D module 440 and/or the secure output renderer 450 can share output memory 474 and/or output processor 484 with secure software application 430, operating system process 420, O & E module 410, input module 400, output device 460 and/or other modules, applications and/or processes.

In some embodiments, D & D module 440 can be a software-based module and/or interface (stored or executed in memory and/or executed at a processor), such as a custom output driver configured to decrypt and/or de-obfuscate secured input data and send it to secure output renderer 450 via, for example, a PCI (Peripheral Component Interconnect) bus connection (not shown in FIG. 4). In some embodiments, D & D module 440 can be configured to decrypt encrypted input data and send the decrypted, but still obfuscated input data, to secure output renderer 450. In such embodiments, secure output renderer 450 can be a custom, hardware-based video and/or graphics card configured to de-obfuscate the received, obfuscated input data prior to transmission to output device 460.

Secure output renderer 450 can be any hardware- and/or software-based module (stored or executed in memory and/or executed at a processor) configured to render input data on an output device, such as output device 460. In some embodiments, secure output renderer 450 can be configured to perform decryption and/or de-obfuscation of input data. In some embodiments, secure output renderer 450 can receive decrypted and/or de-obfuscated input data from D & D module 440. In some embodiments, secure output renderer 450 can be a processor, an application-specific integrated circuit (ASIC), hardware-isolated software (stored or executed in memory and/or executed at a processor), or a field programmable gate array (FPGA). In some embodiments, secure output renderer 450 can be a dedicated video and/or graphics card, or an on-board video processor disposed within or physically coupled to a device motherboard and/or processor (not shown in FIG. 4).

Output device 460 can be any hardware device configured to display visual content for viewing by an observer. For example, output device 460 can be a monitor, such as a cathode-ray tube (CRT), liquid crystal display (LCD), light-emitting diode (LED) or other display. In other embodiments, the output device 460 can be an audio output device, such as, for example, a speaker.

In some embodiments, input module 400 can be configured to receive input data (not shown in FIG. 4), such as any combination of text, audio, video, graphic, image, or other data. In some embodiments, the input data can be entered into input module 400 by a user. In some embodiments, the input data can be received from another source, such as another processor-based device (not shown in FIG. 4).

Upon receipt of the input data, input module 400 can send the input data to O & E module 410. As noted above, in some embodiments, O & E module 410 can be a hardware device disposed within input module 400. In such embodiments, O & E module 410 can receive the input data via a circuit-based connection. As noted above, in some embodiments, O & E module 410 can be a hardware dongle device coupled to input module 400. In such embodiments, O & E module 410 can intercept signals sent by input module 400, including the received input data.

Upon receipt of the input data, O & E module 410 can be configured to transform the input data into an obfuscated and/or encrypted form, such as a diversified obfuscated and/or encrypted form. In some embodiments, O & E module 410 can first obfuscate the input data upon receipt from input module 400. For example, in some embodiments, O & E module 410 can obfuscate codes, such as hardware keyboard scan codes, or virtual keyboard ASCII codes, associated with the input data by using a substitution cipher or other obfuscation method, such as a scan code or ASCII shuffle cipher. In such embodiments, O & E module 410 can include a scan code or ASCII obfuscator module (not shown in FIG. 4) that replaces the standard scan code or ASCII value associated with each keypress entered by a user with an alternative (i.e., obfuscated) scan code or ASCII value. In some embodiments, the scan code obfuscator module can be a diversified scan code obfuscator module, unique to a particular hardware device and/or user, as described herein. In some embodiments, O & E module 410 can perform multiple rounds or layers of obfuscation on the input data. For example, in some embodiments O & E 410 can perform the scan code or ASCII shuffle cipher on the input data and subsequently further obfuscate the data using another substitution cipher method, such as a one-to-many, or homophonic substitution cipher. In some embodiments, input data that has undergone multiple layers of obfuscation by O & E module 410 can be referred to as “super-obfuscated” data.

Having obfuscated the input data, O & E module 410 can next encrypt the obfuscated input data using an encryption algorithm. In some embodiments, the encryption algorithm can be a custom, diversified and/or proprietary encryption algorithm or scheme, such as the encryption methods described herein. In some embodiments, the encryption method or algorithm can be generated such that the encryption algorithm itself is diversified and/or customized to a given user or input module. In some embodiments, the encryption algorithm can be based on one or more of: a pseudo-random number generator, any mathematic operation that yields deterministic results, and/or any valid cryptographic operation.

Upon completion of the encryption process, O & E module 410 can send the obfuscated and encrypted input data to operating system process 420 and/or secure software application 430, thereby defining a first portion of a secure channel (i.e., a data path over which the contents of the input data cannot be discerned by other system processes or modules, software applications, hardware and/or software signal “sniffers”, malware, and the like). In some embodiments, O & E module 410 can send the encrypted and/or obfuscated input data via a wired hardware connection using known protocols for reception of input at a processor-based device (not shown in FIG. 4). For example, in some embodiments O & E module 410 can send the encrypted and/or obfuscated input data via a serial, USB, PS/2 or other known I/O protocol. In other embodiments, O & E module 410 can send the encrypted and/or obfuscated input data via a wireless connection using any suitable wireless protocol.

In some embodiments, the connection between O & E module 410 and operating system process 420 and/or secure software application 430 can be a direct connection. Similarly stated, in such embodiments, O & E module 410 can be operatively connected to operating system process 420 and/or secure software application 430 without any intervening modules or devices (e.g., using a direct cable, within a same physical device and/or using a direct wireless connection). In other embodiments, the connection between O & E module 410 and operating system process 420 and/or secure software application 430 is via a network. In such embodiments, O & E module 410 can be operatively connected to the operating system process 420 and/or the secure software application 430 via an intranet, a local area network (LAN), a wide area network (WAN), a wireless local area network (WLAN), the Internet and/or the like.

11100] Although not shown in FIG. 4, the encrypted and/or obfuscated input data sent by O & E module 410 can typically be first received by standard hardware and software modules (stored or executed in memory and/or executed at a processor) designed to receive and send input data to operating system processes and software applications. For example, in some embodiments, the encrypted and/or obfuscated input data can be delivered to operating system process 420 and/or secure software application 430 via a sequence of: 1) hardware-based input ports; 2) system bus hardware; 3) software-based input drivers; and 4) a system memory 472 from which the operating system process 420 and/or secure software application 430 are being executed by system processor 482.

In some embodiments, O & E module 410 can send the encrypted and/or obfuscated input data to a custom input driver, such as a custom keyboard input driver (not shown in FIG. 4). In such embodiments, the custom keyboard input driver can be configured to perform additional operations on the encrypted and/or obfuscated input data, such as additional obfuscation and/or encryption processes, integrity checks, etc. In some embodiments, the custom keyboard input driver can intercept the encrypted and/or obfuscated input data sent from O & E module 410 such that the custom keyboard input driver has access to the encrypted and/or obfuscated input data before any other hardware- and/or software-based module (stored or executed in memory and/or executed at a processor) associated with the computing device. In such embodiments, the custom keyboard input driver can forward the encrypted and/or obfuscated input data to operating system process 420 and/or secure software application 430 via the sequence of hardware and software modules described above.

As described above, in some embodiments, the input memory 470 used by the O & E module 410 and/or the input module 400 can be protected and/or secured by hardware-based software isolation. In other embodiments not including hardware-based software isolation, the input memory 470 can be protected and/or secured by virtually isolated memory space (also known as “memory curtaining”) and/or obfuscated memory space. In other embodiments, the O & E module 410 and/or the input module 400 can share system memory 472 with secure software application 430 and/or operating system process 420, and/or output memory 474 with D & D module 440 and secure output renderer 450. In some embodiments, one or more drivers associated with the O & E module 410 and/or the input module 400 can operate without the operating system process 420 monitoring the operation of the O & E module 410 and/or the input module 400 (i.e., without operating system awareness). In other embodiments, the operating system process 420 monitors the operation of the O & E module 410 and/or the input module 400.

In some embodiments, prior to sending the encrypted and/or obfuscated input data to operating system process 420 and/or secure software application 430, the O & E module 410 can identify a complementary agent in the secure software application 430 and/or the operating system process 420. After such a complementary agent is identified in the secure software application 430 and/or the operating system process 420, the O & E module 410 can send the encrypted and/or obfuscated input data to the secure software application 430 and/or the operating system process 420. This provides context awareness between the O & E module 410 and the secure software application 430 along with an additional level of security and/or data protection.

In some embodiments, the O & E module 410 can send the encrypted and/or obfuscated input data to multiple operating system processes and/or secure software applications (stored or executed in memory and/or executed at a processor) over a wired and/or wireless network (e.g., a LAN, a WAN, a WLAN, the Internet, etc.). For example, the O & E module 410 can identify multiple operating system processes (e.g., similar to operating system process 420) and/or multiple secure software applications (e.g., similar to secure software application 430) to which the encrypted and/or obfuscated input data is to be sent. Specifically, the O & E module 410 can identify a complementary agent (e.g., a complementary operating system process 420 and/or secure software application 430) on multiple devices and/or nodes within the network. The O & E module 410 can then send the encrypted and/or obfuscated input data to each of the complementary agents.

Upon receipt of the encrypted and/or obfuscated input data from O & E module 410, operating system process 420 (executing in system processor 482) can transport the encrypted and/or obfuscated input data to and/or from various device and/or system resources, such as system processes, software-based modules and/or applications (stored or executed in memory and/or executed at a processor), system peripherals and/or hardware, etc (not shown in FIG. 4). Because encrypted and/or obfuscated input data is obfuscated and/or encrypted, however, in such embodiments neither operating system process 420 nor any observing device, process, or individual is capable of discerning the actual information represented by the encrypted and/or obfuscated input data string or strings. Thus, devices and/or software configured to “sniff” the transmission of information throughout memory as dictated by an operating system process, while capable of capturing the encrypted and/or obfuscated input data strings, will be incapable of using the strings in any useful way. For example, an installed “rootkit” process, hook, code injector or sniffer each is capable of surreptitiously monitoring operating system activity and may be able to capture the encrypted and/or obfuscated input data string(s) as they are transmitted within or by operating system process 420. Such rootkits or similar modules, however, will be incapable of delivering to a user the input data in its plain-text, unobfuscated, unencrypted form, inasmuch as the custom decryption and de-obfuscation techniques used to convert the encrypted and/or obfuscated input data into such form are located only within custom and/or diversified “black box” modules (such as O & E module 410, secure software application 430 and/or D & D module 440).

Upon receipt of encrypted and/or obfuscated input data from O & E module 410, secure software application 430 (e.g., executing in system processor 482) can first decrypt the encrypted and/or obfuscated input data, thereby converting it into an obfuscated-only (i.e., usable) form. In embodiments where the input data has undergone multiple obfuscation operations (and is thus “super-obfuscated”), secure software application 430 can perform a reverse or de-obfuscation process on the super-obfuscated data, leaving intact only the effects of the first layer of obfuscation on the input data. In some embodiments, secure software application 430 can then use the obfuscated input data to provide the particular functionality of that secure software application 430. For example, in some embodiments, secure software application 430 can perform one or more operations on the obfuscated input data, such as a text manipulation operation or other string operation, an arithmetic mathematical operation, etc. In some embodiments, secure software application 430 can use the obfuscated input data as part of any other operation and/or functionality of secure software application 430. In some embodiments, secure software application 430 can transfer the obfuscated input data to another system process or module (not shown in FIG. 4) for storage, display, etc. In such embodiments, secure software application 430 can first perform a second layer of obfuscation on the obfuscated input data and subsequently re-encrypt the then super-obfuscated input data, converting it back to secure form prior to transmission, such that the now-secured input data cannot be interpreted by unsecure processes or modules running on or coupled to the computing device. Thus, at all points during its path through a computing device, the input data is obfuscated, and at least at some points is obfuscated, super-obfuscated and/or encrypted.

In some embodiments, the operating system process 420 and/or secure software application 430 can receive encrypted and/or obfuscated input data from more than a single O & E module 410 over a wired and/or wireless network (e.g., a LAN, a WAN, a WLAN, the Internet, etc.). For example, multiple O & E modules can send encrypted and/or obfuscated input data to a common operating system process 420 and/or secure software application 430 for processing.

In some embodiments, operating system process 420 and/or secure software application 430 can be configured to send encrypted and/or obfuscated input data for eventual output at an output device, such as output device 460. The operating system process or secure software application (such as secure software application 430) thereby defines a second segment or portion of the “secure channel” mentioned above. In such embodiments, the operating system process 420 can send the encrypted and/or obfuscated input data discussed above to D & D module 440. As discussed above, in some embodiments, D & D module 440 can be physically or operatively coupled to output renderer 450. In such embodiments, D & D module 440 can decrypt and/or de-obfuscate the encrypted and/or obfuscated input data.

In some embodiments, prior to sending the encrypted and/or obfuscated input data to D & D module 440, the operating system process 420 and/or secure software application 430 can identify a complementary agent in the D & D module 440. After such a complementary agent is identified in the D & D module 440, the operating system process 420 and/or secure software application 430 can send the encrypted and/or obfuscated input data to the D & D module 440. This provides context awareness between the D & D module 440 and the secure software application 430 along with an additional level of security and/or data protection.

In some embodiments, the connection between D & D module 440 and operating system process 420 and/or secure software application 430 (executing in processor 482) can be a direct connection. Similarly stated, in such embodiments, D & D module 440 can be operatively connected to operating system process 420 and/or secure software application 430 without any intervening modules or devices (e.g., using a direct cable, within a same device and/or using a direct wireless connection). In other embodiments, the connection between D & D module 440 and operating system process 420 and/or secure software application 430 (executing in processor 482) is via a network. In such embodiments, D & D module 440 can be operatively connected to operating system process 420 and/or secure software application 430 via an intranet, a local area network (LAN), a wide area network (WAN), a wireless local area network (WLAN), the Internet and/or the like.

In some embodiments, the operating system process 420 and/or secure software application 430 can send the encrypted and/or obfuscated input data to more than a single device over a wired and/or wireless network (e.g., a LAN, a WAN, a WLAN, the Internet, etc.). For example, the operating system process 420 and/or secure software application 430 can identify multiple devices to which the encrypted and/or obfuscated input data is to be sent. Specifically, the operating system process 420 and/or secure software application 430 can identify a complementary agent (e.g., a complementary D & D module similar to D & D module 440) on multiple devices and/or nodes within the network. The operating system process 420 and/or secure software application 430 can then send the encrypted and/or obfuscated input data to each of the complementary agents.

In some embodiments, D & D module 440 can decrypt the encrypted and/or obfuscated input data by executing the appropriate decryption steps as dictated by the obfuscation and/or encryption algorithm used by O & E module 410 described above. In some embodiments, D & D module 440 can de-obfuscate the decrypted input data by “unshuffling” or decoding the obfuscated data. For example, in some embodiments, D & D module 440 can include a scan code or ASCII de-obfuscator module (not shown in FIG. 4) that replaces the obfuscated scan code or ASCII value for each scan code or ASCII value of the input data with the actual scan code value, thereby returning the input data into a simple obfuscated or fully de-obfuscated, interpretable form. In some embodiments, D & D module 440 can perform multiple de-obfuscation operations on the obfuscated or super-obfuscated data as appropriate to return the input data into a fully or partially de-obfuscated, interpretable form.

After converting the input data into a plain-text or obfuscated form, in some embodiments, D & D module 440 can send the plain-text or obfuscated input data directly to secure output renderer 450. For example, in embodiments in which D & D module 440 is a hardware-based module disposed within or physically coupled to output renderer 450, and secure output renderer 450 is a hardware video card, D & D module 440 can send the plain-text or obfuscated PCI data directly to the video card for immediate rendering on or by output device 460. In such embodiments, if the input data is in obfuscated form when it reaches secure output renderer 450, secure output renderer 450 can de-obfuscate the input data prior to sending it to output device 460. In other embodiments, in which D & D module 440 is a software-based module (stored or executed in memory and/or executed at a processor), such as a software-based output driver, D & D module 440 can send the plain-text or obfuscated input data directly (i.e., bypassing the operating system) to output renderer 450 via the device's PCI bus for immediate rendering by or on the output device 460.

As described above, in some embodiments, the output memory 474 used by the D & D module 440 and/or the secure output renderer 450 can be protected and/or secured by hardware-based software isolation. In other embodiments not including hardware-based software isolation, the output memory 474 can be protected and/or secured by virtually isolated memory space (also known as “memory curtaining”) and/or obfuscated memory space. In other embodiments, the D & D module 440 and/or the secure output renderer 450 can share system memory 472 with secure software application 430 and/or operating system process 420, and/or input memory 470 with O & E module 410 and input module 400. In some embodiments, one or more drivers associated with the D & D module 440 and/or the secure output renderer 450 can operate without the operating system process 420 monitoring the operation of the D & D module 440 and/or the secure output renderer 450 (i.e., without operating system awareness). In other embodiments, the operating system process 420 monitors the operation of the D & D module 440 and/or the secure output renderer 450.

It should be noted that in each of the above-described embodiments, plain-text or obfuscated input data is available only to the secure (or “black box”) D & D module 440 and the secure output renderer 450. Thus, at no point along the secure channel between secure input module 400 and output renderer 450 is the plain-text input data discernible by any system, application, or other process, inasmuch as the input data is in obfuscated, encrypted form (i.e., “secured form”).

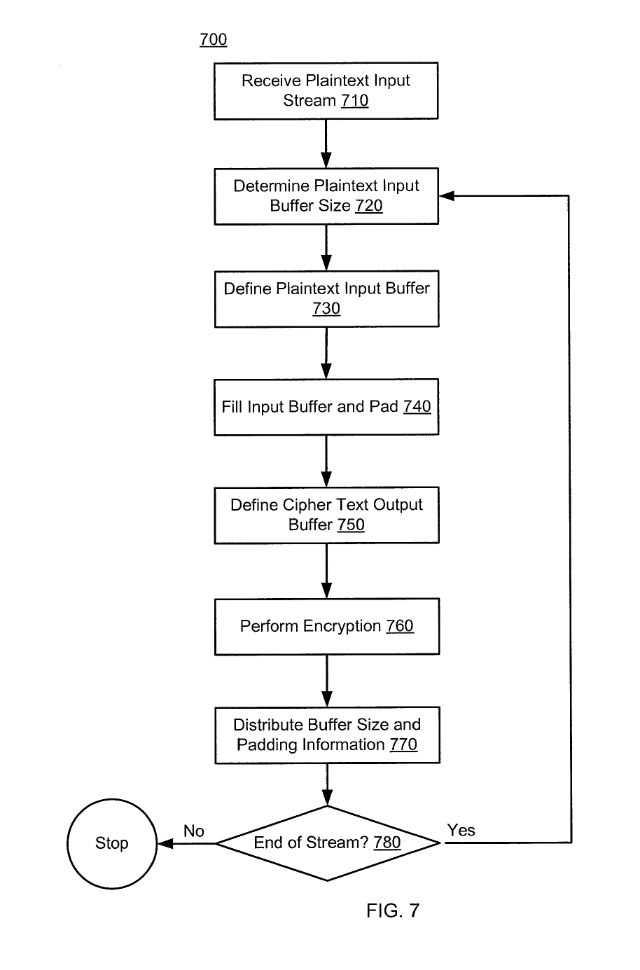

FIG. 7 is a flow chart of a method for performing encryption, according to an embodiment. Method 700 can be implemented (or executed or hosted) by a device including a cryptographic engine. For example, a device including a processor hosting a cryptographic engine can include instructions stored at a memory operatively coupled to the processor that implement method 700.

As illustrated in FIG. 7, a plaintext input stream can be received, at 710. The plaintext input stream can include data that is unecrypted (i.e., is truly plaintext data). In some embodiments, method 700 can be used during multiple encryption (e.g., encrypting data that has already been encrypted) and the plaintext input stream includes data that is encrypted. This encrypted data can be referred to as “plaintext” (e.g., the input) with respect to method 700 to differentiate from the output of method 700 which will be referred to as “cipher text”. In some embodiments, receiving a plaintext input stream includes receiving a notification or other indicator that input data is available at a previously received (or accessed) plaintext input data stream.

A buffer size for the plaintext input data is then determined, at 720, and defined, at 730. A buffer size can be determined based on a number of factors including, for example, a number of bytes, bits or other quantum of data or information in a plaintext input stream. For example, a software module (stored or executed in memory and/or executed at a processor) implementing method 700 can receive a value indicating the number of bytes of data in a plaintext input stream or the software module can request such a value from the source of the plaintext input stream. In some embodiments, the plaintext input buffer size can be determined pseudo randomly at, for example, a pseudo-random number generator. In some embodiments, the plaintext input buffer size can be determined randomly based on some random input such as a number of and/or duration between keystrokes at a keyboard or temperature variations. In some embodiments, a plaintext input buffer size can be defined when a software module implementing method 700 is defined or instantiated.

A plaintext input buffer can be defined, at 730, by allocating memory for a buffer data structure of sufficient size to store an amount of data indicated by the plaintext input buffer size. A buffer data structure can be an array, a queue, a stack, a linked list, a tree, and/or some other data structure and/or portion of memory which can store data from the plaintext input stream. In some embodiments, step 720 is omitted and a variable-size plaintext input buffer can be defined at 730.

The data from the plaintext input stream is added to the plaintext input buffer, at 740. Additionally, padding data (or a pad or pad bits) can be added to the plaintext input buffer to fill the plaintext input buffer if the plaintext input stream does not include enough data to fill the plaintext input buffer. For example, a pad can be used to fill a plaintext input buffer to reduce delay time waiting for sufficient data in the plaintext input stream to fill the plaintext input buffer. More specifically, for example, a pad can be added to a plaintext input buffer to trigger or initiate encryption of the data in the plaintext input buffer if more than a predefined time period passes without additional data becoming available in the plaintext input stream to ensure that a latency-sensitive software service such as a terminal service does not appear or become unresponsive.

After the plaintext input buffer has been filled with data and/or a pad, a cipher text output buffer can be defined, at 750. The cipher text result of encryption of the data stored in the plaintext input buffer can be stored at the cipher text output buffer. The cipher text output buffer can be appropriately sized such that the cipher text output buffer has a size equal to a size of the cipher text result of encryption of the data stored in the plaintext input buffer. In some embodiments, the size of the cipher text output buffer is at least the size of the cipher text result of encryption of the data stored in the plaintext input buffer. In some embodiments, the cipher text output buffer includes additional space or memory in which information related to method 700 such as plaintext input buffer size and/or information about a pad added to data from a plaintext input stream can be stored.

A cipher text output buffer can be defined by allocating memory for a buffer data structure of sufficient size to store an amount of data indicated by the plaintext input buffer size. A buffer data structure can be an array, a queue, a stack, a linked list, a tree, and/or some other data structure and/or portion of memory which can store data resulting from encryption of plaintext data.

The data stored in the plaintext input buffer is encrypted, at 760, after the cipher text output buffer is defined, and the cipher text result of encryption of the data stored in the plaintext input buffer is stored at the cipher text output buffer. The encryption, at 760, can be based on one of a variety of encryption algorithms or processes. For example, the encryption can be based on a diversified encryption algorithm discussed in relation to FIG. 1. In some embodiments, the encryption can be based on a symmetric encryption algorithm. In some embodiments, the encryption can be based on an asymmetric encryption algorithm. In some embodiments, the encryption can be based on multiple encryption algorithms in which the output of one encryption algorithm becomes the input to another encryption algorithms. In other words, the encryption at 760 can include encryption chains (or encryption chaining) In some embodiments, the encryption includes publicly available encryption algorithms and diversified encryption algorithms. In some embodiments, the encryption includes diversified obfuscation such as the obfuscation discussed in relation to FIG. 3.

The cipher text output of the encryption at 760 stored at the cipher text output buffer is modified, at 770, to include information related to the plaintext input buffer size, the cipher text output buffer size, and/or padding information. In other words, as discussed in relation to FIG. 1, information about or related to method 700 can be distributed within the cipher text stored at the cipher text output buffer. In some embodiments, this information can be distributed based on a diversified algorithm such that a software module (stored or executed in memory and/or executed at a processor) implementing a decryption method or process that is complimentary to method 700 can extract the information from the cipher text.

After the information related to method 700 is distributed within the cipher text, the cipher text can be transmitted or sent to another software module and/or device (stored or executed in memory and/or executed at a processor). If the plaintext input stream is empty, at 780, method 700 can stop. If the plaintext input stream is not empty (i.e., data is available at the plaintext input stream), at 780, method 700 can return to step 720 to encrypt the data at the plaintext input stream. In some embodiments, method 700 can wait at 780 until data is available at the plaintext input stream and can then return to step 720 to encrypt the data at the plaintext input stream.

In some embodiments, method 700 can include more or fewer steps than illustrated in FIG. 7. For example, the cipher text output buffer can be statically defined within a software module (stored or executed in memory and/or executed at a processor) implementing method 700 and step 750 can be omitted. Additionally, in some embodiments, steps of method 700 can be rearranged. For example, step 740 can be executed before steps 720 and 730.

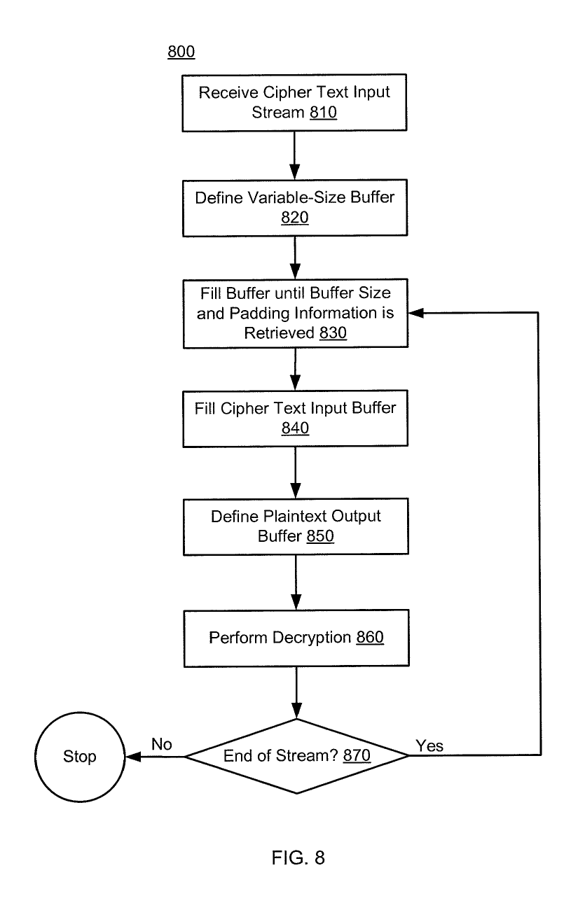

FIG. 8 is a flow chart of a method for performing decryption, according to an embodiment. Similar to method 700, method 800 can be implemented (or executed or hosted) by a device including a cryptographic engine. For example, a device including a processor hosting a cryptographic engine can include instructions stored at a memory operatively coupled to the processor that implement method 800.

As illustrated in FIG. 8, a cipher text input stream can be received, at 810. In some embodiments, receiving a cipher text input stream includes receiving a notification or other indicator that input data is available at a previously received (or accessed) cipher text input data stream. A variable-size buffer is defined, at 820, to store data from the cipher text input stream. A variable-size buffer can be defined by allocating memory for a buffer data structure to store data from the cipher text input buffer. A buffer data structure can be an array, a queue, a stack, a linked list, a tree, and/or some other data structure and/or portion of memory that can store data from the plaintext input stream. The buffer data structure can be defined such that additional memory (or space) can be allocated within the buffer data structure to store additional data if the initial size of the buffer data structure is not sufficient to store data from the cipher text input stream.

The variable-size buffer is filled until buffer size information and padding information are extracted from the data (i.e., cipher text) from the cipher text input stream, at 830. For example, an encryption process such as method 700 can store data related to a plaintext input buffer size (that can vary in size as data in a plaintext input stream is encrypted as discussed above in relation to FIG. 7) and information about a pad added to a plaintext input buffer prior to encryption that produced the cipher text available at the cipher text input stream. That data can be extracted, for example, based on an algorithm shared at a software module (stored or executed in memory and/or executed at a processor) implementing method 700 and a software module (stored or executed in memory and/or executed at a processor) implementing method 800. The software module implementing method 700 and a software module implementing method 800 can be, for example, an agent and a complimentary agent, respectively.

A cipher text input buffer is filled with data from the variable-size buffer based on the information (e.g., buffer size and padding information) extracted from the cipher text, at 840, and a plaintext output buffer can be defined, at 860. A plaintext output buffer can be defined by allocating memory for a buffer data structure of sufficient size to store an amount of data indicated by the plaintext input buffer size. A buffer data structure can be an array, a queue, a stack, a linked list, a tree, and/or some other data structure and/or portion of memory which can store the plaintext result of decryption.

Similar to the discussion of plaintext in relation to FIG. 7, plaintext output can include data that is unencrypted (i.e., is truly plaintext data). In some embodiments, method 800 can be used during decryption of multiple encryption (e.g., decryption data that has already been encrypted multiple times) and the plaintext output includes data that is encrypted. This encrypted data can be referred to as “plaintext” (e.g., the output) with respect to method 800 to differentiate from the input of method 800 which is referred to as “cipher text.”

The cipher text stored at the cipher text input buffer is decrypted, at 860. The decryption at 860 can include the decryption processes, methods and/or algorithms associated with the encryption discussed above in relation to method 700. That is, the decryption at 860 can include individual, multiple and/or chains of decryption based on publicly available encryption algorithms, diversified encryption algorithms, symmetric encryption algorithms, asymmetric encryption algorithms, and/or other encryption. The plaintext output of the decryption can be stored at the plaintext output buffer and further processed and/or sent to one or more other software modules or devices (stored or executed in memory and/or executed at a processor). If the cipher text input stream is empty, at 870, method 800 can stop. If the cipher text input stream is not empty (i.e., data is available at the cipher text input stream), at 870, method 800 can return to step 830 to decrypt the data at the cipher text input stream. In some embodiments, method 800 can wait at 870 until data is available at the cipher text input stream and can then return to step 830 to decrypt the data at the cipher text input stream.

In some embodiments, method 800 can include more or fewer steps than illustrated in FIG. 8. For example, step 820 can be omitted and a statically defined and/or fixed-size buffer can be used in method 800. Furthermore, padding information extracted from cipher text (e.g., at 830) can be used to remove a pad from plaintext data stored at the plaintext output buffer after the decryption at 860 and before further processing the plaintext data. Additionally, in some embodiments, steps of method 800 can be rearranged.

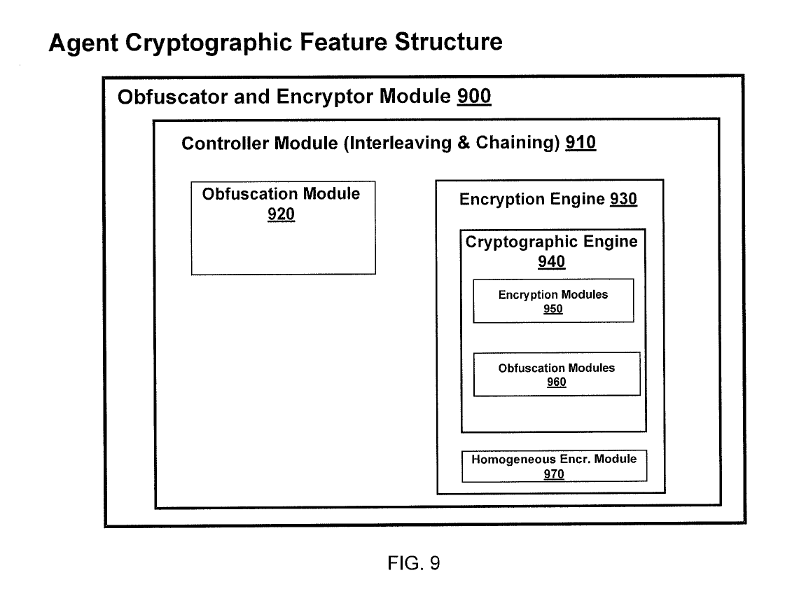

FIG. 9 is a block diagram illustrating the cryptographic feature structure of an obfuscator and encryptor (0 & E) module 900, according to an embodiment. While shown in FIG. 9 as an O & E module 900, in some embodiments, de-obfuscator and decryptor modules can be structured similar to O & E module 900. O & E module 900 can be structurally and functionally similar to O & E module 410, shown and described above with respect to FIG. 4. The O & E module 900 includes at least one obfuscation module 920 and at least one encryption engine 930. The obfuscation module 920 can be similar to the obfuscation modules 520, 530, 620 and 630, shown and described with respect to FIGS. 5 and 6. Similarly, the encryption engine 930 can be similar to the encryption engines 540, 550, 640 and 650, shown and described with respect to FIGS. 5 and 6.

The O & E module 900 also includes a controller module 910, which controls and/or coordinates obfuscation module 920 and encryption engine 930. Specifically, the controller module 910 can control and/or coordinate the rounds of encryption and/or obfuscation as shown and described with respect to FIGS. 5 and 6. Thus, the controller module 910 can determine a sequence of obfuscation and/or encryption algorithms to apply to input data. Similarly stated, the controller module 910 can interleave encryption processes with obfuscation processes and can chain multiple encryption processes and/or obfuscation processes together.

The encryption engine 930 includes a cryptographic engine 940. Cryptographic engine 940 can be structurally and functionally similar to cryptographic engine 250, shown and described with respect to FIG. 2. As such, cryptographic engine 940 includes multiple software modules (stored or executed in memory and/or executed at a processor) configured to perform diversified data encryption (e.g., encryption modules 950) and/or data obfuscation (e.g., obfuscation modules 960).

Encryption modules 950 and/or obfuscation modules 960 can be similar to the modules 251-256, shown and described with respect to FIG. 2. As such, encryption modules 950 and/or obfuscation modules 960 can be configured to implement, execute and/or perform a diversified encryption algorithm or an obfuscation algorithm, respectively. Encryption engine 930 also includes a homogeneous encryption module 970 configured to perform homogeneous encryption algorithms. Accordingly, the controller module 910 can cause and/or instruct the encryption engine 930 to perform both diversified and homogeneous encryption algorithms on input data. Additionally, the controller module 910 can interleave and/or chain multiple diversified and/or homogeneous encryption algorithms and/or processes.

Some embodiments described herein relate to a computer storage product with a computer-readable medium (also can be referred to as a processor-readable medium) having instructions or computer code thereon for performing various computer-implemented operations. The media and computer code (also can be referred to as code) may be those designed and constructed for the specific purpose or purposes. Examples of computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), and Read-Only Memory (ROM) and Random-Access Memory (RAM) devices.

A processor can be, for example, a single physical processor such as a general-purpose processor, an ASIC, a PLD, or a FPGA having a single processing core or a group of processing cores. In some embodiments, a processor can be a group or cluster of processors such as a group of physical processors operatively coupled to a shared clock or synchronization signal, a shared memory, a shared memory bus, and/or a shared data bus. In other words, a processor can be a group of processors in a multi-processor computing device. In some embodiments, a processor can be a group of distributed processors (e.g., computing devices with one or more physical processors) operatively coupled one to another via a communications network. Said differently, a processor can be a group of distributed processors in communication one with another via a communications network. In some embodiments, a processor can be a combination of such processors. For example, a processor can be a group of distributed computing devices, where each computing device includes a group of physical processors sharing a memory bus and each physical processor includes a group of processing cores.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

While various embodiments have been described above, it should be understood that they have been presented by way of example only, not limitation, and various changes in form and details may be made. Any portion of the apparatus and/or methods described herein may be combined in any combination, except mutually exclusive combinations. The embodiments described herein can include various combinations and/or sub-combinations of the functions, components and/or features of the different embodiments described.

For example, while shown and described above as receiving input from a user input (e.g., a keyboard) and outputting the data to a user output device (e.g., a display), in other embodiments the systems and methods described herein can receive input data from a process (e.g., a system process, an application process, a machine-to-machine process, etc.), a machine, a module, and/or a software component (stored or executed in memory and/or executed at a processor) and the output can be to another system process (e.g., a system process, an application process, a machine-to-machine process, etc.), machine, module and/or software component. In some embodiments, such processes, machines, modules, and/or software components can be unrelated to user input and/or output to a user. Referring to FIG. 4, for example, the O & E module 410 can receive input data from a process and D & D module 440 can output the data to another process. Thus, the secure channel between the O & E module 410 and the D & D module 440 can be used to secure convey data between two processes.

While shown and described above as a single process using a single O & E module and/or a single D & D module, in some embodiments, multiple processes can use a common 0 & E module and/or a common D & D module. For example, multiple processes (e.g., system processes, application processes, a machine-to-machine process, etc.), machines, modules, software components and/or user input devices can use a common O & E module. For another example, multiple processes (e.g., system processes, application processes, a machine-to-machine process, etc.), machines, modules, software components and/or output devices can use a common D & D module. In other embodiments, multiple processes (e.g., system processes, application processes, a machine-to-machine process, etc.), machines, modules, software components and/or output devices can use different O & E modules and/or D & D modules.

While shown and described above as using a common encryption and/or obfuscation algorithm between an O & E module, a secure software application and a D & D module, in some embodiments, the encryption and/or obfuscation algorithm between the O & E module and the secure software application can be different than the encryption and/or obfuscation algorithm between the secure software application and the D & D module. For example, an encryption key used between the O & E module and the secure software application can be different than an encryption key used between the secure software application and the D & D module. As such, the secure software application can decrypt and/or de-obfuscate the data received from the O & E module using a first algorithm and can encrypt and/or obfuscate the data using a second algorithm prior to sending the data to the D & D module.

Some embodiments can include a first method that includes defining a first input data size value based on a pseudo-random number and selecting a first mathematical function from a plurality of pre-selected mathematic functions. The first method can further include applying a first input data block and a key to the first mathematic function to generate a first output data block, the first input data block having a size equal to the first input data size value. The first method can further include defining a second input data size value based on a pseudo-random number and selecting a second mathematical function from the plurality of pre-selected mathematic functions, the second mathematical function different being from the first mathematic function. The first method can further include applying a second input data block and a key to the second mathematic function to generate a second output data block, the second input data block of having a size equal to the second input data size value.

In some embodiments of the first method, the key applied to the first mathematical function and the key applied to the second mathematical function are a first key, and the applying the first input data block and the first key to the first mathematic function includes applying a second key to the first mathematic function, the second key being different from the first key. In some embodiments of the first method, the applying the second input data block and the first key to the second mathematic function includes applying a third key to the second mathematic function, the third key being different from the first key and the second key.

In some embodiments of the first method, the first method can further include defining a data set associated with at least one parameter of the first input data block and generating a third output data block based on the first output data block and the data set.

In some embodiments, a second method includes defining a first input data size value based on a pseudo-random number and applying a first input data block and a key to an encryption engine to generate a first output data block, the first input data block having a size equal to the first input data size value. The second method can further include defining a second output data block based on the first output data block and at least one parameter of the first input block. The second method can further include defining a second input data size value based on a pseudo-random number and applying a second input data block and a key to an encryption engine to generate a third output data block, the second input data block of having a size equal to the second input data size value. The second method can further include defining a fourth output data block based on the third output data block and at least one parameter of the second input block. In some embodiments of the second method, the first input data block includes an obfuscated representation of a signal generated at an input module.

In some embodiments, a system includes a computing device including a memory, the computing device configured to host a first cryptographic engine stored at the memory. The first cryptographic engine implements an encryption algorithm. The system can further include an input module operatively coupled to the computing device and including a second cryptographic engine implementing the encryption algorithm and an output module operatively coupled to the computing device including a third cryptographic engine implementing the encryption algorithm. The encryption algorithm is unique to the first cryptographic engine, the second cryptographic engine and the third cryptographic engine.

In some embodiments, the computing device is configured to host a first obfuscation module stored at the memory, the first obfuscation module configured to provide an input data set to the first cryptographic engine. The first obfuscation module implements an obfuscation algorithm. In such embodiments, the input module includes a second obfuscation module, the second obfuscation module configured to provide an input data set to the second cryptographic engine. The second obfuscation module implements the obfuscation algorithm. In such embodiments, the output module includes a third obfuscation module, the third obfuscation module configured to receive an input data set from the third cryptographic engine. The third obfuscation module implements the obfuscation algorithm. The obfuscation algorithm is unique to the first obfuscation module, the second obfuscation module and the third obfuscation module.

What is claimed is:

1. A method, comprising:
generating a round key for each round from one or more rounds for encrypting input data;
partitioning the input data into one or more data blocks for each round, each data block from the one or more data blocks having a size;
generating a block key for each data block from the one or more data blocks for each round from the one or more rounds; and
encrypting each data block from the one or more data blocks using (1) the round key for an associated round from the one or more rounds, (2) the block key for that data block and (3) the data block as inputs to a mathematic operation to produce a cipher text,
a number of rounds from the one or more rounds is variable, at least one of a size of the round key or a number of data blocks are variable for each round from the number of rounds, or
at least one of the size of each data block from the one or more data blocks, a size of the block key for each data block from the one or more data blocks, the mathematic operation for each data block from the one or more data blocks, or a size of the cipher text for each data block from the one or more data blocks are variable for each data block from the one or more data blocks within each round from the one or more rounds.

2. The method of claim 1, further comprising:
generating a parameter associated with at least one of the number of rounds, the size of the round key for a round from the one or more rounds, the number of data blocks for the round, the size of a data block from the one or more data blocks, the size of the block key for the data block, the mathematic operation for the data block, or the size of the cipher text for the data block; and
encrypting the parameter as part of the cipher text such that a decryption module can use the parameter to decrypt the cipher text.

3. The method of claim 1, further comprising:
generating a first parameter associated with at least one of the number of rounds, the size of the round key for a round from the one or more rounds, the number of data blocks for the round, the size of a data block from the one or more data blocks, the size of the block key for the data block, the mathematic operation for the data block, or the size of the cipher text for the data block;
generating a second parameter associated with at least one of the number of rounds, the size of the round key for a round from the one or more rounds, the number of data blocks for the round, the size of a data block from the one or more data blocks, the size of the block key for the data block, the mathematic operation for the data block, or the size of the cipher text for the data block;
distributing the first parameter to a first location within the cipher text based on a first deterministic runtime algorithm, the first location within the cipher text being a random location determined at a compile time;
distributing the second parameter to a second location within the cipher text based on a second deterministic runtime algorithm, the second location within the cipher text being a random location determined at one of runtime or the compile time.

4. The method of claim 1, further comprising:
generating a parameter associated with at least one of the number of rounds, the size of the round key for a round from the one or more rounds, the number of data blocks for the round, the size of a data block from the one or more data blocks, the size of the block key for the data block, the mathematic operation for the data block, or the size of the cipher text for the data block; and
distributing the parameter as an unencrypted part of the cipher text such that a decryption module can use the parameter to decrypt the cipher text.

5. The method of claim 1, further comprising:
receiving the input data as a stream of a plurality of bits; and
buffering, prior to the partitioning, the stream of the plurality of bits until a number of bits corresponding to the size of a data block from the one or more data blocks is buffered.

6. The method of claim 1, further comprising:
receiving the input data as a stream of a plurality of bits; and
appending, prior to the partitioning, at least one pad bit to the plurality of bits to define a second plurality of bits, the number of bits of the second plurality of bits corresponding to the size of a data block from the one or more data blocks.

7. The method of claim 1, further comprising:
generating a parameter associated with at least one of the number of rounds, the size of the round key for a round from the one or more rounds, the number of data blocks for the round, the size of a data block from the one or more data blocks, the size of the block key for the data block, the mathematic operation for the data block, or the size of the cipher text for the data block;
distributing the parameter to a location within the cipher text; and
inserting random symbols determined at the compile time into the cipher text to delineate the parameter from remaining portions of the cipher text.

8. A method, comprising:
defining a first input data size value based on a pseudo-random number;
selecting a first mathematic function from a plurality of pre-selected mathematic functions;
applying a first input data block and a first key to the first mathematic function to generate a first output data block, the first input data block having a size equal to the first input data size value;
defining a second input data size value based on a pseudo-random number;
selecting a second mathematic function from the plurality of pre-selected mathematic functions, the second mathematic function different from the first mathematic function; and
applying a second input data block and a second key to the second mathematic function to generate a second output data block, the second input data block having a size equal to the second input data size value.

9. The method of claim 8, wherein:
the first key and the second key are a common key;
the applying the first input data block and the common key to the first mathematic function includes applying a third key to the first mathematic function, the third key being different from the common key; and
the applying the second input data block and the common key to the second mathematic function includes applying a fourth key to the second mathematic function, the fourth key being different from the common key and the third key.

10. The method of claim 8, further comprising:
defining a data set associated with at least one parameter of the first input data block; and
generating a third output data block based on the first output data block and the data set, a decryption module configured to determine the second mathematic function based on the at least one parameter of the first input data block.

11. The method of claim 8, wherein the selecting the first mathematic function includes pseduo-randomly selecting the first mathematic function from the plurality of pre-selected mathematic functions.

12. The method of claim 8, wherein the selecting the first mathematic function includes pseudo-randomly selecting the first mathematic function from the plurality of pre-selected mathematic functions, the method further comprising:
generate a third output data block based on the second output data block and a seed value used to pseudo-randomly select the first mathematic function.

13. The method of claim 8, wherein the first mathematic function includes at least one of a logical operation, a bit-manipulation operation, an expansion operation, a compaction operation, a substitution operation or an exponentiation operation.

14. The method of claim 8, further comprising:
applying the second output data block to an obfuscation function to generate a third output data block.

15. The method of claim 8, wherein the applying the first input data block and the first key to the first mathematic function is associated with a first round of encryption, the applying the second input data block and the second key to the second mathematic function is associated with a second round of encryption, a number of rounds of encryption being defined by a pseudo-random number generator.

16. The method of claim 8, wherein the first key is different than the second key.

17. A method, comprising:
defining a first input data size value based on a first pseudo-random number;
applying a first input data block and a key to a first encryption engine to generate a first output data block, the first input data block having a size equal to the first input data size value;
defining a second output data block based on the first output data block and at least one parameter of the first input block;
defining a second input data size value based on a second pseudo-random number;
applying a second input data block and a key to a second encryption engine to generate a third output data block, the second input data block of having a size equal to the second input data size value; and
defining a fourth output data block based on the third output data block and at least one parameter of the second input block such that the at least one parameter of the second input block is used to decrypt the third output data block.

18. The method of claim 17, wherein the first input data block includes an obfuscated representation of a signal generated at an input module.

19. The method of claim 17, wherein the at least one parameter of the second input block is a seed value used to pseudo-randomly select the second encryption engine from a plurality of pre-selected encryption engines.

20. The method of claim 17, wherein the at least one parameter of the second input block is a associated with the size equal to the second input data size value.

21. The method of claim 17, further comprising:
applying the fourth output data block to an obfuscation function to generate a fifth output data block.

22. The method of claim 16, wherein the first encryption engine is associated with a mathematic function that is different from a mathematic function associated with the second encryption engine.

23. A system, comprising:
a computing device including a memory, the computing device configured to host a first cryptographic engine stored at the memory, the first cryptographic engine implementing an encryption algorithm;
an input module operatively coupled to the computing device and including a second cryptographic engine implementing the encryption algorithm; and
an output module operatively coupled to the computing device and including a third cryptographic engine implementing the encryption algorithm, the encryption algorithm being unique to the first cryptographic engine, the second cryptographic engine and the third cryptographic engine.

24. The system of claim 23, wherein:
the computing device is configured to host a first obfuscation module stored at the memory, the first obfuscation module configured to provide an input data set to the first cryptographic engine, the first obfuscation module implementing an obfuscation algorithm;
the input module includes a second obfuscation module, the second obfuscation module configured to provide an input data set to the second cryptographic engine, the second obfuscation module implementing the obfuscation algorithm; and
the output module includes a third obfuscation module, the third obfuscation module configured to receive an input data set from the third cryptographic engine, the third obfuscation module implementing the obfuscation algorithm, the obfuscation algorithm being unique to the first obfuscation module, the second obfuscation module and the third obfuscation module.

25. The system of claim 23, wherein the second cryptographic engine is configured to randomly select a mathematic function from a plurality of pre-selected mathematic functions to apply to a data block, the first cryptographic engine and the third cryptographic engine configured to select the mathematic function from the plurality of pre-selected mathematic functions in response to receiving the data block.

26. The system of claim 23, wherein the second cryptographic engine is configured to randomly select a first mathematic function from a plurality of pre-selected mathematic functions to apply to a first data block, the second cryptographic engine configured to randomly select a second mathematic function from the plurality of pre-selected mathematic functions to apply to a second data block, the first mathematic function being different than the second mathematic function.

27. The system of claim 23, wherein the second cryptographic engine is configured to perform at least one of a logical operation, a bit-manipulation operation, an expansion operation, a compaction operation, a substitution operation or an exponentiation operation on a data block.

28. The apparatus of claim 23, wherein the second cryptographic engine is stored within a memory protected by at least one of virtually isolated memory space or obfuscated memory space.
